(19) United States
(12) Patent Application Publication
(10) Pub. No.: US 2025/0263332 A1
(43) Pub. Date: Aug. 21, 2025

(54) TRANSPARENT ARTICLES AND DISPLAY ARTICLES WITH MEDIUM INDEX LAYERS AND HIGH SHALLOW HARDNESS

(71) Applicant: CORNING INCORPORATED, CORNING, NY (US)

(72) Inventors: Shandon Dee Hart, Elmira, NY (US); Carlo Anthony Kosik Williams, Painted Post, NY (US); Lin Lin, Painted Post, NY (US); Naveen Prakash, Fishers, IN (US); James Joseph Price, CORNING, NY (US)

(21) Appl. No.: 19/046,757

(22) Filed: Feb. 6, 2025

Related U.S. Application Data
(60) Provisional application No. 63/554,308, filed on Feb. 16, 2024.

(51) Int. Cl. C03C 17/34; C03C 10/00

(52) U.S. Cl. CPC C03C 17/3435; C03C 10/0027; C03C 2214/20

(57) ABSTRACT

A transparent article is described herein that includes: a substrate; and an optical film structure on the substrate having a thickness of from about 200 to 5000 nm. The optical film structure comprises a scratch-resistant layer, at least one low refractive index (RI), medium RI, and high RI layer, an inner structure disposed on the substrate, and an outer structure comprising alternating high and medium RI layers. Each medium RI layer comprises a refractive index from 1.55 to 1.9, each high RI layer comprises a refractive index greater than 1.80, each low RI layer comprises a refractive index from 1.35 to 1.7.

### CLAIM OF PRIORITY

This application claims the benefit of priority under 35 U.S.C. § 119 of U.S. Provisional Application Ser. No. 63/554,308, filed on Feb. 16, 2024, the content of which is relied upon and incorporated herein by reference in its entirety.

### FIELD

This disclosure relates to transparent articles for protection of optical articles and display devices, and particularly to transparent articles having a substrate with an optical film structure disposed thereon with an outer structure with one or more medium index layers that exhibit various optical and mechanical performance attributes including, but not limited to, high shallow hardness, low reflectance, low glare, high visible and infrared transmittance, low reflected color, color uniformity, minimized overall thickness, and retained strength and drop performance.

### BACKGROUND

Cover articles with glass substrates are often used to protect critical devices and components within electronic products and systems, such as mobile devices, smart phones, computer tablets, hand-held devices, vehicular displays and other electronic devices with displays, cameras, light sources and/or sensors. These cover articles can also be employed in architectural articles, transportation articles (e.g., articles used in automotive applications, trains, aircraft, sea craft, etc.), appliance articles, or any article that requires some transparency, scratch resistance, abrasion resistance, or a combination thereof.

These applications that employ cover glass articles often demand a combination of mechanical and environmental durability, breakage resistance, damage resistance, scratch resistance and strong optical performance characteristics. For example, the cover articles may be required to exhibit high light transmittance, low reflectance and/or low transmitted color in the visible spectrum. In some applications, the cover articles are required to cover and protect display devices, cameras, sensors and/or light sources. Further, recent data suggests that high hardness close to the outer surface of the optical structures of cover articles can appreciably improve scratch and abrasion resistance, particularly for scratches that originate from sliding motions with low applied normal forces.

Further, conventional cover articles employing glass or glass-ceramic substrates and optical film structures can suffer from reduced article-level mechanical performance. In particular, the inclusion of optical film structures on these substrates has provided advantages in terms of optical performance and certain mechanical properties (e.g., scratch resistance); however, conventional combinations of these substrates and optical film structures (e.g., as optimized for improved scratch resistance with high modulus and/or hardness) has resulted in inferior strength and/or drop test performance for the resultant article. Notably, it appears that the presence of the optical film structure on the substrate can disadvantageously reduce the strength and/or drop test performance of the article to a level below that of the substrate in a bare form without the optical film structure.

Accordingly, there is a need for improved cover articles for protection of optical articles and devices, particularly transparent articles that exhibit high shallow hardness (or high hardness more generally), low reflectance, low glare, high visible and infrared transmittance, low reflected color, and color uniformity, along with, in some instances, damage resistance, high modulus and/or high fracture toughness. There is also a need for the foregoing transparent articles which employ optical film structures with minimized overall thickness and as-deposited warp levels, with retained hardness and strength. Further, there is a need for the foregoing transparent articles in which their bare substrate strength and drop performance levels are improved, retained, or substantially retained (e.g., at or above an application-driven threshold), after the inclusion of their optical film structures. These needs, and other needs, are addressed by the present disclosure.

### SUMMARY

According to an aspect of the disclosure, a transparent article is provided that includes: a substrate comprising a first primary surface and a second primary surface, the primary surfaces opposing one another; and an optical film structure having an outer surface and a physical thickness of from about 200 nm to 5000 nm, the optical film structure disposed on the first primary surface. The optical film structure comprises a scratch-resistant layer, at least one low refractive index (RI) layer, at least one medium RI layer, and at least one high RI layer. The optical film structure further comprises an outer structure and an inner structure, the scratch-resistant layer disposed between the outer and inner structures, the inner structure disposed on the first primary surface, and the outer structure comprising a plurality of alternating high and medium RI layers. The outer structure comprises at least one medium RI layer in contact with one or both of: (a) the scratch-resistant layer and (b) one of the high RI layers. The at least one medium RI layer comprises a refractive index from 1.55 to 1.9, each of the high RI layers comprises a refractive index of greater than 1.80, each of the low RI layers comprises a refractive index from 1.35 to 1.7, each medium RI layer has a higher refractive index than each low RI layer, and each high RI layer has a higher refractive index than each medium RI layer. The article exhibits a first-surface average photopic reflectance of less than 1%, as measured from 0° to 10° incidence. Further, the article exhibits a color shift of less than 15 for all thickness scaling factors from 70-100% for the optical film structure, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

According to an aspect of the disclosure, a transparent article is provided that includes: a substrate comprising a first primary surface and a second primary surface, the primary surfaces opposing one another; and an optical film structure having an outer surface and a physical thickness of from about 500 nm to 2000 nm, the optical film structure disposed on the first primary surface. The optical film structure comprises a scratch-resistant layer, low refractive index (RI) layers, medium RI layers, and high RI layers. The optical film structure further comprises an outer structure and an inner structure, the scratch-resistant layer disposed between the outer and inner structures, the inner structure disposed on the first primary surface and comprising a plurality of alternating high and low RI layers, and the outer structure comprising a plurality of alternating high and medium RI layers. The outer structure comprises at least one medium RI layer in contact with one or both of: (a) the scratch-resistant layer and (b) one of the high RI layers. Further, each medium RI layer of the outer structure comprises a refractive index from 1.55 to 1.65, each of the high RI layers comprises a refractive index of greater than 1.80, and each of the low RI layers comprises a refractive index from 1.35 to 1.55, and wherein the article exhibits a first-surface average photopic reflectance of less than 1%, as measured from 0° to 10° incidence.

According to an aspect of the disclosure, a transparent article is provided that includes: a substrate comprising a first primary surface and a second primary surface, the primary surfaces opposing one another; and an optical film structure having an outer surface and a physical thickness of from about 200 nm to 5000 nm, the optical film structure disposed on the first primary surface. The optical film structure comprises a scratch-resistant layer, low refractive index (RI) layers, medium RI layers, and high RI layers. The optical film structure further comprises an outer structure and an inner structure, the scratch-resistant layer disposed between the outer and inner structures, the inner structure disposed on the first primary surface and comprising a plurality of alternating high and low RI layers, and the outer structure comprising a plurality of alternating high and medium RI layers. The outer structure has a physical thickness of from 400 nm to 800 nm and comprises at least one medium RI layer in contact with one or both of: (a) the scratch-resistant layer and (b) one of the high RI layers. The at least one medium RI layer comprises a refractive index from 1.55 to 1.9, each of the high RI layers comprises a refractive index of greater than 1.80, each of the low RI layers comprises a refractive index from 1.35 to 1.7, each medium RI layer has a higher refractive index than each low RI layer, and each high RI layer has a higher refractive index than each medium RI layer. Further, the article exhibits a mean failure height of at least 75 cm, as measured according to a Drop Test Method with 80 grit garnet sandpaper.

According to other aspects of the disclosure, a display device is provided that includes one or more of the foregoing transparent articles, with each article serving as a protective cover for the display device.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments, wherein:

FIG. 1A is a cross-sectional side view of a transparent article (e.g., for a display device), according to one or more embodiments of the disclosure;

FIG. 1B (PRIOR ART) is a cross-sectional side view of a comparative transparent article;

FIG. 2A is a plan view of an exemplary electronic device incorporating any of the transparent articles disclosed herein;

FIG. 2B is a perspective view of the exemplary electronic device of FIG. 2A;

FIG. 2C is a perspective view of an alternative embodiment of the electronic device of FIG. 2A with a non-planar substrate having curved or faceted edges, according to one or more embodiments of the disclosure;

FIGS. 3A and 4A (PRIOR ART) are plots of first-surface reflectance vs. wavelength, as measured at a near-normal incident angle of 8°, for the transparent articles of FIGS. 1A and 1B, respectively;

FIGS. 3B and 4B (PRIOR ART) are plots of single-sided, reflected color, as measured at incident angles from 0° to 90° with various optical film structure thickness scaling factors, for the transparent articles of FIGS. 1A and 1B, respectively;

FIG. 5A is a plan view of an exemplary device-drop machine that may be used to conduct the Drop Test Metho, according to one or more embodiments of the disclosure;

FIG. 5B is a plan view of the machine of FIG. 5A, wherein a check of the device-drop machine is release, chuck jaws open, and a puck is released;

FIG. 5C is a plan view of the machine of FIG. 5A, wherein the falling puck strikes a drop surface;

FIG. 6A is an image of an exemplary device-drop machine that may be used to conduct the Drop Test Method, according to one or more embodiments of the disclosure;

FIG. 6B is a cross-section of a simulated mobile handheld device that may be used to conduct the Drop Test Method, according to one or more embodiments of the disclosure;

FIG. 6C is another view of a simulated mobile handheld device that may be used to conduct the Drop Test Method, according to one or more embodiments of the disclosure;

FIG. 6D is a schematic view of one face of a simulate mobile handheld device that may be used to conduct the Drop Test Method, according to one or more embodiments of the disclosure;

FIG. 6E is an image of an exemplary simulated mobile handheld device that may be used to conduct the Drop Test Method, according to one or more embodiments of the disclosure;

FIG. 6F is an image of an exemplary drop surface that may be used to conduct the DROP Test Method, according to one or more embodiments of the disclosure; and

FIG. 7 is a bar chart of mean failure height data for a transparent article of the disclosure and two comparative articles, as measured according to the Drop Test.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between material and the surface. The intervening material(s) may constitute a layer, as defined herein.

As used herein, the terms “low RI layer”, “medium RI layer” and “high RI layer” refer to the relative values of the refractive index (“RI”) of layers of an optical film structure of a transparent article according to the disclosure. Hence, the RI of the low RI layer <the RI of the medium RI layer <the RI of the high RI layer, unless otherwise expressly noted in this disclosure. Accordingly, low RI layers have refractive index values that are less than the refractive index values of medium and high RI layers. Further, as used herein, “low RI layer” and “low index layer” are interchangeable with the same meaning. Likewise, “medium RI layer” and “medium index layer” are interchangeable with the same meaning. Similarly, “high RI layer” and “high index layer” are interchangeable with the same meaning.

As used herein the term “glass-ceramic substrate” is not limited to glass-ceramic substrates. Rather, the term “glass-ceramic substrate” refers to a group of substrates that are inclusive of glass-ceramic substrates, ceramic substrates, glass substrates, sapphire substrates, strengthened glass substrates, and strengthened glass-ceramic substrates.

As used herein, the term “strengthened substrate” refers to a substrate employed in a transparent article of the disclosure that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of a single optical film structure or the outer optical film structure of a transparent article of the disclosure with the diamond Berkovich indenter to form an indent to an indentation depth in the range from about 50 nm to about 1000 nm (or the entire thickness of the outer or inner optical film structure, whichever is less) and measuring the maximum hardness from this indentation along the entire indentation depth range or a segment of this indentation depth (e.g., in the range from about 100 nm to about 600 nm), generally using the methods set forth in Oliver, W.C.; Pharr, G. M. An improved technique for determining hardness and elastic modulus using load and displacement sensing indentation experiments. J. Mater. Res., Vol. 7, No. 6, 1992, 1564-1583; and Oliver, W.C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

As used herein, the term “transmittance” is defined as the percentage of incident optical power within a given wavelength range transmitted through a material (e.g., the article, the substrate or the optical film or portions thereof). The term “reflectance” is similarly defined as the percentage of incident optical power within a given wavelength range that is reflected from a material (e.g., the article, the substrate, or the optical film or portions thereof). Transmittance and reflectance are measured using a specific linewidth. As used herein, an “average transmittance” refers to the average amount of incident optical power transmitted through a material over a defined wavelength regime. As used herein, an “average reflectance” refers to the average amount of incident optical power reflected by the material.

As used herein, “photopic reflectance” mimics the response of the human eye by weighting the reflectance or transmittance, respectively, versus wavelength spectrum according to the human eye's sensitivity. Photopic reflectance may also be defined as the luminance, or tristimulus Y value of reflected light, according to known conventions such as CIE color space conventions. The “average photopic reflectance”, as used herein, for a wavelength range from 380 nm to 720 nm is defined in the below equation as the spectral reflectance, R(λ) multiplied by the illuminant spectrum, I(λ) and the CIE's color matching function y̅(λ), related to the eye's spectral response:

$$〈 {R}_{p} 〉 = {\int }_{380 nm}^{720 nm} R ( λ ) \times I ( λ ) \times \overline{y} ( λ ) d λ$$

In addition, “average reflectance” can be determined over the visible spectrum, or over other wavelength ranges, according to measurement principles understood by those skilled in the field of the disclosure, e.g., in the infrared spectrum from 840 nm to 950 nm, etc. Unless otherwise noted, all reflectance values reported or otherwise referenced in this disclosure are associated with testing through both primary surfaces of the substrate and optical film structure(s) of the transparent articles of the disclosure, e.g., a “two-surface” average photopic reflectance. In cases where “one-surface” or “first-surface” reflectance is specified, the reflectance from the rear surface of the article is eliminated through optical bonding to a light absorber, allowing the reflectance of only the first surface to be measured.

The usability of a transparent article in an electronic device (e.g., as a protective cover) can be related to the total amount of reflectance in the article. Photopic reflectance is particularly important for display devices that employ visible light. Lower reflectance in a cover transparent article over a lens and/or a display associated with the device can reduce multiple-bounce reflections in the device that can generate ‘ghost images’. Thus, reflectance has an important relationship to image quality associated with the device, particularly its display and any of its other optical components (e.g., a lens of a camera). Low-reflectance displays also enable better display readability, reduced eye strain, and faster user response time (e.g., in an automotive display, where display readability can also correlate to driver safety). Low-reflectance displays can also allow for reduced display energy consumption and increased device battery life, since the display brightness can be reduced for low-reflectance displays compared to standard displays, while still maintaining the targeted level of display readability in bright ambient environments.

As used herein, “photopic transmittance” is defined in the below equation as the spectral transmittance, T(λ) multiplied by the illuminant spectrum, I(λ) and the CIE's color matching function y̅(λ), related to the eye's spectral response:

$$〈 {T}_{p} 〉 = {\int }_{380 nm}^{720 nm} T ( λ ) \times I ( λ ) \times \overline{y} ( λ ) d λ$$

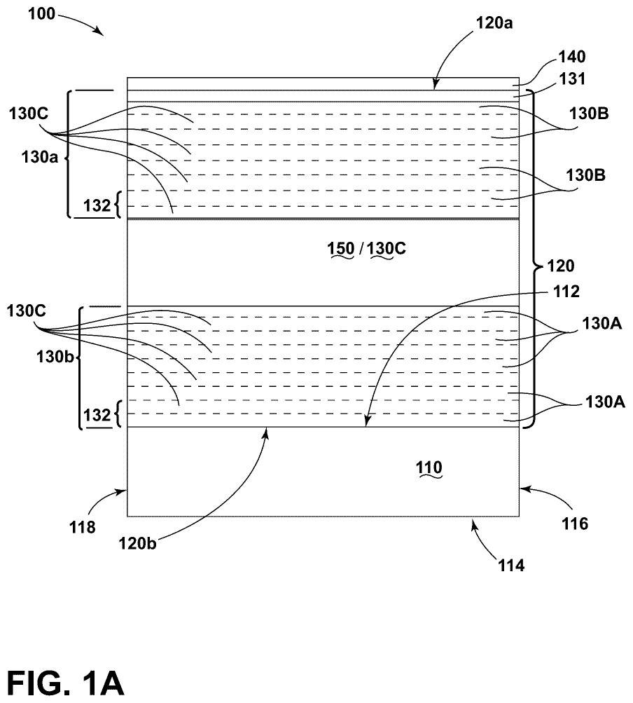

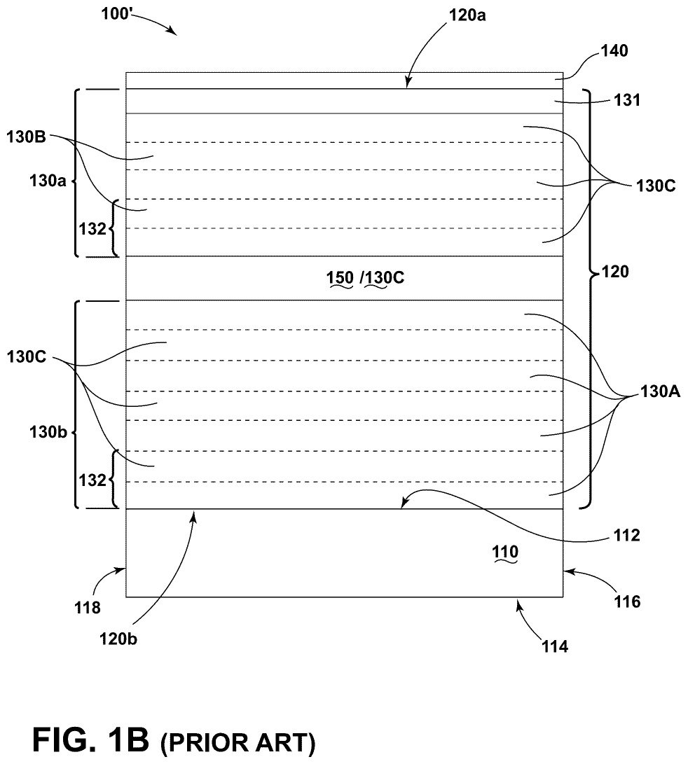

In addition, “average transmittance” or “average photopic transmittance” can be determined over the visible spectrum or other wavelength ranges, according to measurement principles understood by those skilled in the field of the disclosure, e.g., in the infrared spectrum from 840 nm to 950 nm, etc. Unless otherwise noted, all transmittance values reported or otherwise referenced in this disclosure and claims are associated with testing through both primary surfaces of the substrate and the optical film structure (e.g., the substrate 110, primary surfaces 112, 114, and optical film structure 120 as shown in FIGS. 1A-1D and described below) of the transparent articles, e.g., a “two-surface” average photopic transmittance.

As used herein, “transmitted color” and “reflected color” refer to the color transmitted or reflected through the transparent articles of the disclosure with regard to color in the CIE L*,a*,b* colorimetry system under a D65 illuminant. More specifically, the “color shift” (i.e., as measured in transmission or reflectance) is given by √(a*²+b*²), as these color coordinates are measured through transmission or reflectance of a D65 illuminant through the primary surfaces of the substrate of the transparent article (e.g., the substrate 110, primary surfaces 112, 114, and optical film structure 120 as shown in FIGS. 1A-1D and described below) over an incident angle range, e.g., from 0 degrees to 10 degrees.

As also used herein, an “optical film structure thickness scaling factor” and “thickness scaling factor” are interchangeable and generally refer to expected differences in the thickness of the optical film structures of the disclosure that can occur from vapor deposition of the optical film structure on a non-planar substrate or non-planar portions of a substrate. These optical film structure thickness differences as a function of methods employed to deposit these structures on substrates are detailed in following co-assigned: (1) U.S. Pat. No. 10,802,179 B2; (2) U.S. Pat. No. 11,500,130 B2; and (3) U.S. Patent Publication No. 2023/0273345, the salient portions of which are related to thickness scaling factors and similar concepts are hereby incorporated by reference in this disclosure. In turn, these variances in the thickness of the optical film structure may result in non-uniformity of transmitted and/or reflected color exhibited by the transparent articles of the disclosure possessing such optical film structures. As such, transmitted and reflected color values are reported in this disclosure for various thickness scaling factors such that “100%” corresponds to color measurements on an optical film structure on a planar surface of the substrate or at the maximum thickness of the optical film structure on a surface of the substrate, “90%” corresponds to the color measurements on an optical film structure on a non-planar surface having 90% of the thickness of the portion of the optical film structure on an adjacent planar surface or the portion of the optical film structure on a surface of the substrate having a maximum thickness, and so on.

As used herein, the “Drop Test Method” involves performing face-drop testing on a puck with a transparent article attached thereto, as set forth in U.S. Non-Provisional patent application Ser. No. 18/527,526, filed on Dec. 4, 2023, entitled “Coated Glass Articles”, the salient portions of which are incorporated herein by reference in their entirety.

Generally, the disclosure is directed to transparent articles that employ optical film structures over substrates, including strengthened substrates. Further, these transparent articles can include a high toughness, high modulus glass-ceramic substrate that is optically transparent, with a high-hardness optical coating having controlled transmittance and color. In view of this combination of substrate and optical film structure, the transparent article can exhibit a high shallow hardness, while also exhibiting transparency, low reflectance, high visible and IR transmittance, and low color. In addition, transparent articles of the disclosure can advantageously exhibit failure strength levels (e.g., according to the Drop Test Method) that are the same as, or substantially close to, the failure strength levels of a bare glass-ceramic substrate.

Further, the transparent articles of the disclosure exhibit an advantageous combination of mechanical and optical properties over known transparent articles, including one or more of the following: an average photopic reflectance of <1%, an average infrared (940 nm) reflectance of <2%, a color shift of less than 15 for all thickness scaling factors from 70-100%, a mean failure height of at least 75 cm according to the Drop Test Method, an optical film structure with a total physical thickness of ≤2000 nm, and an optical film structure with outer structure having a total physical thickness from 400-800 nm and/or at least one medium RI layer with a refractive index from 1.55-1.65.

In aspects of these transparent articles, the optical film structures are configured such that the articles that employ them exhibit a hardness of at least about 10 GPa, at least about 11 GPa, or even at least about 12 GPa, at a Barkovich nanoindentation depth of about 125 nm from the outer surface of the optical film structure. The optical film structure may comprise a multilayer optical interference film composed of SiO₂, SiOₓ, SiOₓN_{y}, SiN_{y}, and/or Si₃N₄ layers, which comprises a scratch-resistant layer (e.g., as embedded within the structure). According to some implementations, an outer structure of the optical film structure above the scratch-resistant layer can be configured with at least one medium RI layer (e.g., SiOₓN_{y}) in contact with one of the high RI layers and the scratch-resistant layer (e.g., SiOₓN_{y} or SiN_{y}) and/or a sum of the physical thicknesses of all of the low RI layers (e.g., SiO₂ or SiOₓN_{y}) in the outer structure limited to about 75 nm or more. Some or all of these structural characteristics can enable or otherwise significantly influence the achievement of these shallow high hardness levels.

The transparent articles of the disclosure can be employed for protection and/or covers of displays, camera lenses, sensors and/or light source components within or otherwise part of electronic devices, along with protection of other components (e.g., buttons, speakers, microphones, etc.). These transparent articles with a protective function employ an optical film structure disposed on a substrate such that the article exhibits a combination of high shallow hardness and desirable optical properties. Advantageously, these shallow high hardness levels are exhibited by the transparent articles of the disclosure without an appreciable loss in optical properties, e.g., low reflectance in the visible and IR spectra and low reflected color.

As also outlined in the disclosure, the foregoing, advantageous article-level high shallow hardness levels can be achieved through the control of the composition and/or arrangement of the optical film structures employed in the transparent articles. Notably, these hardness levels can be achieved by the articles of the disclosure while maintaining desired optical properties. In terms of optical properties, the transparent articles of the disclosure can exhibit an average first-surface photopic reflectance of less than 2%, 1.5%, or even 1%, and a first-surface reflectance at a wavelength of 940 nm of less than 2.5%, 2%, or even 1.7%, all as measured at a near-normal angle of incidence) (0-10°.

The transparent articles with a protective function can also employ an optical film structure disposed on a glass-ceramic substrate such that the article exhibits a combination of high hardness, high damage resistance and desirable optical properties, including high photopic transmittance and low transmitted color. The optical film structure can include a scratch-resistant layer, at any of various locations within the structure. Further, the outer structure of the optical film structures of these articles can include a plurality of alternating high and low refractive index layers, with each high index layer and a scratch resistant layer comprising nitride or an oxynitride and each low index layer comprising an oxide.

With regard to mechanical properties, embodiments of the transparent articles of the disclosure can exhibit a maximum hardness of 12 GPa or greater or 13 GPa or greater (or even greater than 14 GPa in some instances), as measured by a Berkovich Hardness Test over an indentation depth range from 100 nm to about 500 nm in the optical film structure. The glass-ceramic substrates employed in these articles can have an elastic modulus of greater than 85 GPa, or greater than 95 GPa in some instances. These glass-ceramic substrates also can exhibit a fracture toughness of greater than 0.8 MPa·√m, or greater than 1 MPa·√m in some instances.

According to some embodiments of the transparent articles of the disclosure, advantageous article-level failure stress levels can be achieved through the control of the composition, arrangement and/or processing of the optical film structures employed in the transparent articles. Notably, the composition, arrangement and/or processing of the optical film structures can be adjusted to obtain residual compressive stress levels of at least 700 MPa (e.g., from 700 to 1100 MPa) and an elastic modulus of at least 140 GPa (e.g., from 140 to 170 GPa, from 140 to 180 GPa, from 140 to 190 GPa, or from 140 to 200 GPa). These optical film structure mechanical properties correlate to average failure stress levels of 500 MPa or greater, 600 MPa or greater, or even 700 MPa or greater, in the transparent articles employing these optical film structures, as measured in an ROR test with the outer surface of the optical film structure of the article placed in tension.

Referring to FIG. 1A, a transparent article 100 according to one or more embodiments may include a substrate 110, and an optical film structure 120 defining an outer surface 120a and an inner surface 120b disposed on the substrate 110. The substrate 110 includes opposing primary surfaces 112, 114 and opposing secondary surfaces 116, 118. The optical film structure 120 is shown in FIG. 1A, with its inner surface 120b disposed on a first opposing primary surface 112 and no optical film structures are shown as being disposed on the second opposing primary surface 114. In some embodiments, however, one or more of the optical film structures 120 can be disposed on the second opposing primary surface 114 and/or on one or both of the opposing secondary surfaces 116, 118.

The optical film structure 120 includes at least one layer of material. As used herein, the term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layer may be formed by any known method in the art, including discrete deposition or continuous deposition processes. In one or more embodiments, the layer may be formed using only continuous deposition processes, or, alternatively, only discrete deposition processes.

In one or more embodiments, a single layer or multiple layers of the optical film structure 120 may be deposited onto a glass or glass-ceramic substrate 110 by a vacuum deposition technique such as, for example, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used such as spraying, dipping, spin coating, or slot coating (e.g., using sol-gel materials). Generally, vapor deposition techniques may include a variety of vacuum deposition methods which can be used to produce thin films. For example, physical vapor deposition uses a physical process (such as heating or sputtering) to produce a vapor of material, which is then deposited on the object which is coated. Preferred methods of fabricating the optical film structure 120 can include reactive sputtering, metal-mode reactive sputtering and PECVD processes.

The optical film structure 120 may have a physical thickness of from about 100 nm to about 5 microns. For example, the optical film structure 120 may have a thickness greater than or equal to about 200 nm, 300 nm, 325 nm, 350 nm, 375 nm, 400 nm, 500 nm, 600 nm, 700 nm, 800 nm, 900 nm, 1 micron, 2 microns, 3 microns, 4 microns, and less than or equal to about 5 microns. In some implementations of the transparent articles 100 depicted in FIGS. 1A-1D, the optical film structure 120 has a physical thickness from 200 nm to 5000 nm, 500 nm to 2000 nm, or 1500 nm to 2000 nm, and all sub-ranges and thickness values between the foregoing ranges.

In some embodiments, as depicted for example in FIG. 1A, the optical film structure 120 is divided into an outer structure 130a and an inner structure 130b, with a scratch-resistant layer 150 (as detailed further below) disposed between the structures 130a and 130b. In these embodiments, the outer and inner optical film structures 130a and 130b may have the same thicknesses or different thicknesses, and each comprises one or more layers.

Referring again to the transparent article 100 depicted in FIG. 1A, the optical film structure 120 includes one or more scratch-resistant layer(s) 150. For example, the transparent article 100 depicted in FIG. 1A includes an optical film structure 120 with a scratch-resistant layer 150 disposed over a primary surface 112 of the substrate 110. According to one embodiment, the scratch-resistant layer 150 may comprise one or more materials chosen from SiᵤAlᵥOₓN_{y}, Ta₂O₅, Nb₂O₅, AlN, AlNₓ, SiAl,N_{y}, AlNₓ/SiAlₓN_{y}, Si₃N₄, AlOₓN_{y}, SiOₓ N_{y}, SiN_{y}, SiNₓ:H_{y}, HfO₂, TiO₂, ZrO₂, Y₂O₃, Al₂O₃, MoO₃, diamond-like carbon, or combinations thereof. Exemplary materials used in the scratch-resistant layer 150 may include an inorganic carbide, nitride, oxide, diamond-like material, or combinations thereof. Examples of suitable materials for the scratch-resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 150 may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y}, and combinations thereof. In some implementations, the scratch-resistant layer 150 may include Si₃N₄, SiN_{y}, SiOₓN_{y}, and combinations thereof. In some embodiments, each of the scratch-resistant layers 150 employed in the transparent article 100 may exhibit an effective fracture toughness value greater than about 1 MPa√m and simultaneously exhibits a hardness value greater than about 10 GPa, as measured by a Berkovich Hardness Test.

Each of the scratch-resistant layers 150, as shown in exemplary form in the transparent article 100 depicted in FIG. 1A, can be comprised of any of the foregoing materials such that it exhibits a refractive index (RI) of greater than 1.80. In some implementations, the RI of the scratch-resistant layer 150 is greater than 1.55, 1.60, 1.65, 1.80, 1.85, or greater than 1.90. For example, the RI of the scratch-resistant layer 150 can be 1.55, 1.60, 1.65, 1.70, 1.75, 1.80, 1.85, 1.9, 1.95, 2.0, 2.05, 2.10, 2.15, 2.20, 2.25, 2.3, 2.35, 2.4, 2.45, 2.5, and all RI values between the foregoing values.

Each of the scratch-resistant layers 150, as shown in exemplary form in the transparent article 100 depicted in FIG. 1A, may be relatively thick as compared with other layers (e.g., low RI layers 130A, high RI layers 130B, medium RI layers 130C, capping layer 131, etc.) such as greater than or equal to about 50 nm, 75 nm, 100 nm, 150 nm, 200 nm, 250 nm, 300 nm, 325 nm, 350 nm, 375 nm, 400 nm, 425 nm, 450 nm, 475 nm, 500 nm, 525 nm, 550 nm, 575 nm, 600 nm, 700 nm, 800 nm, 900 nm, 1 micron, 1.5 microns, or even 2 microns. For example, a scratch-resistant layer 150 may have a thickness from about 50 nm to about 3 microns, from about 100 nm to about 2.5 microns, from about 150 nm to about 2 microns, from about 500 nm to 2500 nm, from about 500 nm to about 2000 nm, from about 500 nm to about 1500 nm, and all thickness levels and ranges between the foregoing ranges. In other implementations, the scratch-resistant layer 150 may have a thickness from about 100 nm to about 2,000 nm, from about 500 nm to about 1500 nm, or from about 750 nm to about 1250 nm.

As shown in FIG. 1A, and outlined above, the transparent articles 100 of the disclosure include an optical film structure 120 with one or more of an outer structure 130a and inner structure 130b. The optical film structure 120 includes a scratch-resistant layer 150, at least one low RI layer 130A, at least one medium RI layer 130C, and at least one high RI layer 130B. In embodiments, the optical film structure 120 includes a plurality of alternating low RI and high RI layers, 130A and 130B, respectively. The outer structure 130a of the optical film structure 120 includes a plurality of alternating medium RI and high RI layers, 130C and 130B. In some embodiments, the inner structure 130b includes a plurality of alternating low RI and high RI layers, 130A and 130B, respectively. In other embodiments, the inner structure 130b includes one or more layers having a graduated or gradient in refractive index, e.g., with refractive index values that span between the refractive index ranges of low RI and high RI layers 130A, 130B, respectively, or between the refractive index values of the substrate 110 and the scratch resistant layer 150. In some preferred implementations, the outer structure 130a includes at least one medium RI layer 130C in contact with one of the high RI layers 130B and the scratch-resistant layer 150. In some preferred implementations, the outer structure 130a is inclusive of at least one outermost capping layer 131 (e.g., with a refractive index within the range of those specified for low RI layers 130A), as depicted in exemplary form in FIG. 1A.

According to embodiments, each of the outer and inner structures 130a and 130b includes a period 132 of two or more layers, such as the low RI layer 130A and high RI layer 130B; or a low RI layer 130A, high RI layer 130B and a low RI layer 130A; or a high RI layer 130B and a medium RI layer 130C. Further, each of the outer and inner structures 130a and 130b of the optical film structure 120 may include a plurality of periods 132, such as 1 to 30 periods, 1 to 25 periods, 1 to 20 periods, and all periods within the foregoing ranges. In addition, the number of periods 132, the number of layers of the outer and inner structures 130a and 130b, and/or the number of layers within a given period 132 can differ or they may be the same. Further, in some implementations, the total amount of the plurality of alternating low RI and high RI layers 130A and 130B and/or medium RI layers 130C and high RI layers 130B, along with the scratch-resistant layer 150, may range from 6 to 50 layers, 6 to 40 layers, 6 to 30 layers, 6 to 28 layers, 6 to 26 layers, 6 to 24 layers, 6 to 22 layer, 6 to 20 layers, 6 to 18 layers, 6 to 16 layers, and 6 to 14 layers, and all ranges of layers and amounts of layers between the foregoing values.

As an example, in FIG. 1A, each of the periods 132 of the inner and outer structures 130a, 130b, respectively, includes a low RI layer 130A and a high RI layer 130B or a medium RI layer 130C and a high RI layer 130B. When a plurality of periods is included in either or both of the outer and inner structures 130a and 130b, the low RI layers 130A (designated as “L”), the medium RI layers 130C (designated “M”), and the high RI layers 130B (designated as “H”) can alternate in the following sequence of layers: L/H/L/H . . . , H/L/H/L . . . , M/H/M/H . . . , H/M/H/M . . . , such that the low RI layers 130A and the high RI layers 130B, or the medium RI layers 130C and the high RI layers 130B, alternate along the physical thickness of the outer and inner structures 130a, 130b of the optical film structure 120. In preferred implementations, as shown in FIG. 1A, the periods 132 in the outer structures 130a are configured as M/H/M/H . . . above the scratch-resistant layer 150; and the periods 132 in the inner structures 130b are configured as L/H/L/H . . . above the substrate 110 and beneath the scratch-resistant layer 150.

In an implementation of the transparent article 100, as shown in FIG. 1A, the number of periods 132 of the outer and inner structures 130a and 130b can be configured such that the outer structure 130a includes a total of eight (8) alternating layers (e.g., alternating medium and high RI layers 130C and 130B); and the inner structure 130b includes at least nine (9) layers (e.g., alternating low RI and high RI layers 130A, 130B, respectively). Further, in this implementation, the outer structure 130a of the optical film structure 120 includes a capping layer 131 (similar in structure and thickness to a low RI layer 130A) over the outer structure 130a; and the optical film structure 120 includes a scratch-resistant layer 150 disposed between the outer and inner structures 130a and 130b. Accordingly, in the implementation depicted in exemplary form in FIG. 1A, the optical structure 120 includes a total of 19 layers.

According to some implementations of the transparent articles 100 of the disclosure, each of the outer and inner structures 130a and 130b of the optical film structure 120 has a total of at least 7, 8, 9, 10, 11, 12, 13, 14, or even 15 layers. According to some embodiments of the transparent articles 100 of the disclosure, the optical film structure 120 has a total of at least 15, 16, 17, 18, 19, 20, 25, or even 30 layers. In one preferred implementation of the transparent article 100, as depicted in FIG. 1A, the outer structure 130a includes at least four (4) medium RI layers 130C, at least four (4) high RI layers 130B, and one of the high RI layers 130B is in contact with an outermost capping layer 131 (e.g., a low RI layer 130A).

According to some embodiments of the transparent article 100 depicted in FIG. 1A, the outermost capping layer 131 of the optical film structure 120 and outer structure 130a may not be exposed but instead have a top coating 140 disposed thereon. In some implementations of the transparent article 100, each high RI layer 130B of the optical film structure 120, along with the outer and inner structures 130a, 130b, comprises a nitride, a silicon-containing nitride (e.g., SiN_{y}, Si₃N₄), an oxynitride, or a silicon-containing oxynitride (e.g., SiAlₓO_{y}N_{z} or SiOₓN_{y}). Further, according to some embodiments, each low RI layer 130A of the optical film structure 120, along with the outer and inner structures 130a, 130b, comprises an oxide, a silicon-containing oxide (e.g., SiO₂, SiOₓ or SiO₂ as doped with Al, N or F), or a silicon-containing oxynitride (e.g., SiOₓN_{y}). In addition, according to some embodiments, the scratch-resistant layer 150 and each medium RI layer 130C of the optical film structure 120 comprises an oxynitride or a silicon-containing oxynitride (e.g., SiAlₓO_{y}N_{z} or SiOₓN_{y}). In a preferred implementation of the transparent article 100 depicted in FIG. 1A, the outer structure 130a comprises a plurality of alternating high RI layers 130B of SiNₓ and medium RI layers 130C of SiOₓ N_{y} (along with an optional capping layer 131 of SiO₂ or SiOₓN_{y}); and the inner structure 130b comprises a plurality of alternating high RI layers 130B of SiOₓ N_{y} and low RI layers 130A of SiO₂.

In one or more embodiments of the transparent article 100 depicted in FIG. 1A, the term “low RI”, when used with the low RI layers 130A and/or capping layer 131, includes a refractive index range of less than 1.7, from about 1.3 to about 1.55, from about 1.35 to about 1.55, from about 1.35 to about 1.7, and all indices within these ranges. In one or more embodiments, the term “medium RI”, when used with the medium RI layers 130C, includes a refractive index range from 1.55 to 1.9, 1.55 to 1.80, 1.55 to 1.65, 1.56 to 1.80, 1.6 to 1.75, and all indices within these ranges. In one or more embodiments, the term “high RI”, when used with the high RI layers 130B and/or scratch-resistant layer 150, includes a refractive index range of greater than 1.80, greater than 1.90, from about 1.8 to about 2.5, from about 1.8 to about 2.3, or from about 1.90 to about 2.5, and all indices between these ranges. Further, in a specific implementation, the medium RI layer(s) of the transparent articles 100 of the disclosure (see, e.g., FIG. 1A), may include a refractive index range from 1.55 to 1.90, 1.55 to 1.85, 1.55 to 1.75, 1.55 to 1.65, and all values between these ranges. In one or more embodiments, the difference in the refractive index of each of the low RI layers 130A (and/or capping layer 131), the medium RI layers 130C, and/or the high RI layers 130B (and/or scratch-resistant layer 150) may be about 0.01 or greater, about 0.05 or greater, about 0.1 or greater, or even about 0.2 or greater. In general, for a given embodiment, the definition of which layers in the optical film structure 120 are high RI, medium RI, and low RI will be defined by their relative values, that is, the RI value of the high RI layers 130B is greater than the RI value of the medium RI layers 130C, and the RI value of the medium RI layers 130C is greater than the RI value of the low RI layers 130A.

Example materials suitable for use in the outer and inner structures 130a and 130b of the optical film structure 120 of the transparent article 100 depicted in FIG. 1A include, without limitation, SiO₂, SiOₓ, Al₂O₃, SiAlₓO_{y}, GeO₂, SiO, AlOₓN_{y}, AlN, AlNₓ, SiAlₓN_{y}, SiN_{y}, SiOₓ N_{y}, SiAlₓO_{y}N_{z}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, diamond-like carbon and combinations thereof. Some examples of suitable materials for use in a low RI layer 130A and the outermost capping layer 131 include, without limitation, SiO₂, SiOₓ, Al₂O₃, SiAlₓO_{y}, GeO₂, SiO, AlOₓN_{y}, SiOₓ N_{y}, SiAlₓO_{y}N_{z}, MgO, MgAlₓO_{y}, MgF₂, BaF₂, CaF₂, DyF₃, YbF₃, YF₃, and CeF₃. In some implementations of the transparent article 100, each of its low RI layers 130A includes a silicon-containing oxide (e.g., SiO₂ or SiOₓ) or a silicon-containing oxynitride (e.g., SiOₓN_{y}). The nitrogen content of the materials for use in a low RI layer 130A may be minimized (e.g., in materials such as SiOₓN_{y}, Al₂O₃ and MgAlₓO_{y}). Some examples of suitable materials for use in a high RI layer 130B include, without limitation, SiAl—O_{y}N_{z}, Ta₂O₅, Nb₂O₅, AlN, AlNₓ, SiAl N_{y}, AlNₓ/SiAl,N_{y}, Si₃N₄, AlOₓN_{y}, SiOₓN_{y}, SiN_{y}, SiNₓ:H_{y}, HfO₂, TiO₂, ZrO₂, Y₂O₃, Al₂O₃, MoO₃, and diamond-like carbon. Some examples of suitable materials for use in a medium RI layer 130C include, without limitation, SiAlₓO_{y}N_{z}, AlOₓN_{y}, SiOₓN_{y}, HfO₂, Y₂O₃, and Al₂O₃. According to some implementations, each high RI layer 130B of the outer and inner structures 130a, 130b includes a silicon-containing nitride or a silicon-containing oxynitride (e.g., Si₃N₄, SiN_{y}, or SiOₓN_{y}). In one or more embodiments, each of the high RI layers 130B may have high hardness (e.g., hardness of greater than 8 GPa), and the high RI materials listed above may comprise high hardness and/or scratch resistance.

The oxygen content of the materials for the high RI layer 130B may be minimized, especially in SiN_{y} materials. Further, exemplary SiOₓN_{y} high RI materials may comprise from about 0 atom % to about 20 atom % oxygen, or from about 5 atom % to about 15 atom % oxygen, while including 30 atom % to about 50 atom % nitrogen. The foregoing materials may be hydrogenated up to about 30% by weight. Where a material having a medium refractive index is desired as a medium RI layer 130C, some embodiments may utilize SiOₓN_{y}, e.g., with a relatively low level of nitrogen (e.g., less than 10%, less than 5%, or less than 3%). It should be understood that a scratch-resistant layer 150 of the transparent articles 100 may comprise any of the materials disclosed as suitable for use in a high RI layer 130B or a medium RI layer 130C.

In one or more embodiments of the transparent article 100, the optical film structure 120 includes a scratch-resistant layer 150 that can be integrated as a medium RI layer 130C, and one or more low RI layers 130A, high RI layers 130B, medium RI layers 130C, and/or a capping layer 131 may be positioned over the scratch-resistant layer 150. Also, with regard to the scratch-resistant layer 150, as shown in FIG. 1A, an optional top coating 140 may also be positioned over the layer 150. The scratch-resistant layer 150 may be alternately defined as the thickest medium RI layer 130C in the overall optical film structure 120 and/or in the outer and the inner structures 130a, 130b.

Without being bound by theory, it is believed that the transparent article 100 depicted in FIG. 1A may exhibit increased hardness at low indentation depths (e.g., 100-125 nm) when one or more medium RI layers 130C (e.g., as comprising SiOₓN_{y}) is placed in direct contact with one or more high RI layers 130B (e.g., SiOₓN_{y}, SiN_{y}) in the outer structure 130a; the outer structure 130a is comprised of alternating layers of high RI layers 130B and medium RI layers 130C (which replaces alternating high RI layers 130B and low RI layers 130A in known optical film structures); the sum of the physical thicknesses of the low RI layers 130A and/or the capping layer 131 in the outer structure 130a is minimized; and the total thickness of the layers in the outer structure 130a is minimized. In some implementations, an additional, repeating medium RI layer 130C can be deployed in the outer structure 130a in contact with another medium RI layer 130C or scratch-resistant layer 150 to also increase hardness at shallow depths within the optical film structure 120. According to some implementations, the sum of the physical thicknesses of the low RI layers 130A and/or the capping layer 131 in the outer structure 130a is configured to be less than about 275 nm, less than about 250 nm, less than about 225 nm, less than about 200 nm, less than about 175 nm, less than about 150 nm, less than about 125 nm, less than 110 nm, less than 100 nm, less than 90 nm, less than 75 nm, or even less than 65 nm, which can also increase hardness at shallow depths within the optical film structure 120. For example, the sum of the physical thicknesses of the low RI layers 130A and/or the capping layer 131 in the outer structure 130a can be 250 nm, 225 nm, 200 nm, 175 nm, 150 nm, 125 nm, 120 nm, 110 nm, 100 nm, 90 nm, 80 nm, 70 nm, and all total thickness values between the foregoing values. Further, in some implementations, the total physical thickness of the layers in the outer structure 130a of the transparent articles 100 depicted in FIG. 1A can be configured to be less than 1000 nm, less than 900 nm, or less than 800 nm, and greater than 400 nm, 450 nm, or even 500 nm, and all total thickness values in the foregoing ranges.

In one or more embodiments, the transparent article 100 depicted in FIG. 1A may include one or more additional top coatings 140 disposed on the outer structure 130a of the optical film structure 120. In one or more embodiments, the additional top coating 140 may include a surface modifying layer such as a fingerprint hiding coating, anti-fingerprint hiding layer or an easy-to-clean coating. Examples of a suitable anti-fingerprint hiding layer and easy-to-clean coatings are described in the following U.S. patent applications: U.S. Patent Application Publication No. 2014/0113083, published on Apr. 24, 2014, entitled “Process for Making of Glass Articles with Optical and Easy-to-Clean Coatings”; U.S. Provisional Patent Application No. 63/603,156, filed on Nov. 28, 2023, entitled “Coated Articles with a Surface-Modifying Layer and Methods of Making the Same”; U.S. Provisional Patent Application No. 63/546,775, filed on Nov. 1, 2023, entitled “Coated Articles with a Planarization Layer and a Surface-Modifying Layer and Methods of Making the Same”; and U.S. Non-Provisional patent application Ser. No. 18/528,916, filed on Dec. 5, 2023, entitled “Coated Articles with an Anti-Fingerprint Coating or Surface-Modifying Layer and Methods of Making the Same”, all of which are incorporated herein by reference in their entirety. The easy-to-clean coating can be a fluorine-containing material. Alternatively, the easy-to-clean coating (anti-fingerprint coating) can include a partial silica-like network having a ratio of Si—O—Si bonds to Si atoms in the coating from about 2 to about 3, the coating is fluorine-free, and the coating further comprises an alkyl silane at the exterior surface and bonded to Si—O groups in the anti-fingerprint coating. The easy-to-clean coating may have a thickness in the range from about 5 nm to about 50 nm and may include known materials such as fluorinated or non-fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating of the top coating 140 may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm, from about 7 nm to about 10 nm, from about 1 nm to about 90 nm, from about 5 nm to about 90 nm, from about 10 nm to about 90 nm, or from about 5 nm to about 100 nm, and all ranges and sub-ranges therebetween.

The top coating 140 may include a scratch-resistant layer or layers which comprise any of the materials disclosed as being suitable for use in the scratch-resistant layer 150. In some embodiments, the additional top coating 140 includes a combination of easy-to-clean material and scratch-resistant material. In one example, the combination includes an easy-to-clean material and diamond-like carbon. Such an additional top coating 140 may have a thickness in the range from about 5 nm to about 20 nm. The constituents of the additional coating 140 may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a-C—H.

According to embodiments of the transparent article 100 depicted in FIG. 1A, each of the low RI layers 130A and high RI layers 130B of the outer and inner structures 130a, 130b of the optical film structure 120 can have a physical thickness that ranges from about 5 nm to 1000 nm, 5 nm to 500 nm, about 5 nm to 250 nm, about 5 nm to 200 nm, and all thicknesses and ranges of thickness between these values. For example, each of these low RI layers 130A and high RI layers 130B can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels. Further, according to embodiments of the transparent article 100 depicted in FIG. 1A, each of the scratch-resistant layer 150 and medium RI layers 130C of the outer and inner structures 130a, 130b of the optical film structure 120 can have a physical thickness that ranges from about 5 nm to 2500 nm, 5 nm to 2000 nm, about 5 nm to 1500 nm, about 5 nm to 1000 nm, and all thicknesses and ranges of thickness between these values. For example, each of the medium RI layers 130C (as not employed as a scratch-resistant layer 150) can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels. Further, according to some implementations, each of the low RI layers 130A (e.g., a capping layer 131), medium RI layers 130C and high RI layers 130B of the outer structure 130a can have a physical thickness that ranges from about 5 nm to 250 nm, about 5 nm to 200 nm, about 5 nm to 175 nm, and all thicknesses and ranges of thickness between these values. As an example, each of these layers 130A-130C can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels.

The substrate 110 of the transparent article 100 depicted in FIG. 1A may include an inorganic material with amorphous and crystalline portions. The substrate 110 may be formed from man-made materials and/or naturally occurring materials (e.g., quartz). In some specific embodiments, the substrate 110 may specifically exclude polymeric, plastic and/or metal substrates. The substrate 110 may be characterized as an alkali-including substrate (i.e., the substrate includes one or more alkalis). In one or more embodiments, the substrate 110 exhibits a refractive index in the range from about 1.5 to about 1.6. In specific embodiments, the substrate 110 (e.g., a strengthened glass or glass-ceramic substrate) may exhibit an average strain-to-failure at a surface on one or more opposing primary surfaces 112, 114 that is 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater or even 2% or greater, as measured using an ROR Test using at least 5, at least 10, at least 15, or at least 20 samples to determine the average strain-to-failure value. In specific embodiments, the substrate 110 may exhibit an average strain-to-failure at its surface on one or more opposing primary surfaces 112, 114 of about 1.2%, about 1.4%, about 1.6%, about 1.8%, about 2.2%, about 2.4%, about 2.6%, about 2.8%, or about 3% or greater.

The term “strain-to-failure” refers to the strain at which cracks propagate in the outer or inner structures 130a, 130b of the optical film structure 120, substrate 110, or both simultaneously without application of additional load, typically leading to catastrophic failure in a given material, layer or film and perhaps even bridge to another material, layer, or film, as defined herein. That is, breakage of the optical film structure 120 (i.e., as including outer and/or inner structures 130a, 130b) without breakage of the substrate 110 constitutes failure, and breakage of the substrate 110 also constitutes failure. The term “average” when used in connection with average strain-to-failure or any other property is based on the mathematical average of measurements of such property on 5 samples. Typically, crack onset strain measurements are repeatable under normal laboratory conditions, and the standard deviation of crack onset strain measured in multiple samples may be as little as 0.01% of observed strain. Average strain-to-failure as used herein was measured using an ROR Test. However, unless stated otherwise, strain-to-failure measurements described herein refer to measurements from the ring-on-ring testing, as described in International Publication No. WO2018/125676, published on Jul. 5, 2018, entitled “Coated Articles with Optical Coatings Having Residual Compressive Stress,” and incorporated herein by reference in its entirety.

Suitable substrates 110 (e.g., a glass or glass-ceramic substrate) may exhibit an elastic modulus (or Young's modulus) in the range from about 60 GPa to about 130 GPa. In some instances, the elastic modulus of the substrate 110 may be in the range from about 70 GPa to about 120 GPa, from about 80 GPa to about 110 GPa, from about 80 GPa to about 100 GPa, from about 80 GPa to about 90 GPa, from about 85 GPa to about 110 GPa, from about 85 GPa to about 105 GPa, from about 85 GPa to about 100 GPa, from about 85 GPa to about 95 GPa, and all ranges and sub-ranges therebetween (e.g., ˜103 GPa). In some implementations, the elastic modulus of the substrate 110 may be greater than 85 GPa, greater than 90 GPa, greater than 95 GPa, or even greater than 100 GPa. In some examples, Young's modulus may be measured by sonic resonance (ASTM E1875), resonant ultrasound spectroscopy, or nanoindentation using Berkovich indenters. Further, suitable substrates 110 (e.g., glass-ceramic substrates) may exhibit a shear modulus in the range from about 20 GPa to about 60 GPa, from about 25 GPa to about 55 GPa, from about 30 GPa to about 50 GPa, from about 35 GPa to about 50 GPa, and shear modulus ranges and sub-ranges therebetween (e.g., ˜43 GPa). In some implementations, the substrate 110 may have a shear modulus of greater than 35 GPa, or even greater than 40 GPa. Further, the substrates 110 can exhibit a fracture toughness of greater than 0.8 MPa·√m, greater than 0.9 MPa·√m, greater than 1 MPa·√m, or even greater than 1.1 MPa·√m in some instances (e.g., ˜1.15 MPa·√m).

In one or more embodiments, an amorphous substrate 110 may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of lithia. According to some embodiments, the substrate 110 can have the following composition: 50-70 mol % SiO₂; 10-20 mol % Al₂O₃; 0-2 mol % P₂O₅; 1-6 mol % B₂O₃; 5-10 mol % Li₂O; 1-10 mol % Na₂O; and 0.01-1.0 mol % K₂O. According to an embodiment, the substrate 110 can have the following composition: 61-67 mol % SiO₂; 12-18 mol % Al₂O₃; 0.25-1.25 mol % P₂O₅; 2-4 mol % B₂O₃; 6-9 mol % Li₂O; 3-6 mol % Na₂O; and 0.1-0.5 mol % K₂O. In one implementation, the substrate 110 has the following composition: 64.9 mol % SiO₂; 15.53 mol % Al₂O₃; 0.86 mol % P₂O₅; 3.21 mol % B₂O₃; 7.2 mol % Li₂O; 4.78 mol % Na₂O; 0.21 mol % K₂O; 0.54 mol % MgO; 0.18 mol % TiO₂; 1.47 mol % CaO; 0.02 mol % Fe₂O₃; 0.01 mol % ZrO₂; 0.04 mol % SnO₂; and 1.07 mol % SrO. In one or more alternative embodiments, the substrate 110 may include crystalline substrates such as glass ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

In one or more embodiments, the substrate 110 includes one or more glass-ceramic materials and may be strengthened or non-strengthened. In one or more embodiments, the substrates 110 as a glass-ceramic material may comprise one or more crystalline phases such as lithium disilicate, lithium metasilicate, petalite, beta quartz, and/or beta spodumene, as potentially combined with residual glass in the structure. In an embodiment, the substrate 110 comprises a disilicate phase. In another implementation, the substrate 110 comprises a disilicate phase and a petalite phase. According to an embodiment, the substrate 110 has a crystallinity of at least 40% by weight. In some implementations, the substrate 110 has a crystallinity of at least about 40%, 45%, 50%, 55%, 60%, 65%, 70%, 75%, 80%, 85%, or greater (by weight), with the residual as a glass phase. Further, according to some embodiments, each of the crystalline phases of the substrate 110 has an average crystallite size of less than 100 nm, less than 75 nm, less than 50 nm, less than 40 nm, less than 30 nm, and all crystallite sizes within or less than these levels. According to one exemplary embodiment, the substrate 110 comprises lithium disilicate and petalite phases with 40 wt. % lithium disilicate, 45 wt. % petalite, and the remainder as residual glass (i.e., ˜85% crystalline, and ˜15% residual amorphous/glass); each crystalline phase having a majority of crystals with an average crystallite size in the range of 10 nm to 50 nm.

Embodiments of the substrate 110 employed in the transparent article 100 of the disclosure (see, e.g., FIG. 1A) can exhibit a refractive index that is higher than refractive indices of conventional glass substrates or strengthened glass substrates. For example, the refractive index of the substrates 110 can range from about 1.52 to 1.65, from about 1.52 to 1.64, from about 1.52 to 1.62, or from about 1.52 to 1.60, and all refractive indices within the foregoing ranges (e.g., as measured at a visible wavelength of 589 nm). As such, conventional optical coatings, which are typically optimized for glass substrates and their refractive index ranges, are not necessarily suitable for use with substrates 110 as comprising glass-ceramic material of the transparent articles 100 of the disclosure. In particular, the layers of the optical film structure 120 between the substrate 110 and the scratch-resistant layer 150 can be modified to achieve low reflectance and low color generated by the transition zone between the glass-ceramic substrate 110 and the scratch-resistant layer 150. This layer re-design requirement can also be described as optical impedance matching between the substrate 110 and the scratch-resistant layer 150.

According to implementations, the substrate 110 is substantially optically clear, transparent and free from light scattering. In such embodiments, the substrate 110 may exhibit an average light transmittance over the optical wavelength regime of about 80% or greater, about 81% or greater, about 82% or greater, about 83% or greater, about 84% or greater, about 85% or greater, about 86% or greater, about 87% or greater, about 88% or greater, about 89% or greater, about 90% or greater, about 91% or greater, about 92% or greater, about 93% or greater, or even about 94% or greater. In some embodiments, these light reflectance and transmittance values may be a total reflectance or total transmittance (taking into account reflectance or transmittance on both primary surfaces 112, 114 of the substrate 110) or may be observed on a single-side of the substrate 110 (i.e., on the primary surface 112 only, without taking into account the opposite surface 114). Unless otherwise specified, the average reflectance or transmittance of the substrate 110 alone is measured at an incident illumination angle of 0 degrees relative to the primary surface 112 (however, such measurements may be provided at incident illumination angles of 45 degrees or 60 degrees).

Additionally, or alternatively, the physical thickness of the substrate 110 may vary along one or more of its dimensions for aesthetic and/or functional reasons. For example, the edges of the substrate 110 may be thicker as compared to more central regions of the substrate 110. In other implementations, the edges of the substrate 110 may be thinner as compared to more central regions of the substrate 110. Further, in some embodiments, portions of the substrate 110 (e.g., edge portions) may be non-planar (e.g., beveled, chamfered, curved, etc.). The length, width and physical thickness dimensions of the substrate 110 may also vary according to the application or use of the article 100.

The substrate 110 may be provided using a variety of different processes. For instance, where the substrate 110 includes an amorphous portion or phase such as glass, various forming methods can include float glass processes and down-draw processes such as fusion draw and slot draw.

Once formed, a substrate 110 may be strengthened to form a strengthened substrate, e.g., through chemical strengthening by an ion exchange process, thermal tempering, and/or utilizing a mismatch of the coefficient of thermal expansion between portions of the substrate to create compressive stress and central tension regions.

Where the substrate 110 is chemically strengthened by an ion exchange process, the ions in the surface layer of the substrate 110 are replaced by—or exchanged with-larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate 110 in a salt bath (or baths), use of multiple salt baths, additional steps such as annealing, washing, and the like, are generally determined by the composition of the substrate 110 and the desired compressive stress (CS), depth of compressive stress layer (or depth of layer) of the substrate 110 that result from the strengthening operation. By way of example, ion exchange of alkali metal-containing substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 530° C., while immersion times range from about 15 minutes up to about 40 hours. However, temperatures and immersion times different from those described above may also be used. In some embodiments, the substrate 110 may be subjected to more than one ion-exchange process. For example, a first ion exchange process can be carried out in a sodium-containing bath, exchanging sodium in the bath for lithium in the glass or glass-ceramic substrate 110 to establish a depth of compression (DOC), while subsequently a second ion-exchange process is carried out on the same glass or glass-ceramic substrate in a potassium-containing bath to establish a depth of layer of potassium ions (DOL) and further increase the compressive stress in the substrate 110 near the surface.

The degree of chemical strengthening achieved by ion exchange may be quantified based on the parameters of central tension (CT), surface CS, depth of compression (DOC) (i.e., the point in the substrate in which the stress state changes from compression to tension), and depth of layer of potassium ions (DOL). Compressive stress (including surface CS) is measured by a surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass-ceramic material. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Refracted near-field (RNF) method or a scattered light polariscope (SCALP) technique may be used to measure the stress profile. When the RNF method is utilized to measure the stress profile, the maximum CT value provided by SCALP is utilized in the RNF method. In particular, the stress profile measured by RNF is force balanced and calibrated to the maximum CT value provided by a SCALP measurement. The RNF method is described in U.S. Pat. No. 8,854,623, issued Oct. 7, 2014, entitled “Systems and Methods for Measuring a Profile Characteristic of a Glass Sample”, which is incorporated herein by reference in its entirety. In particular, the RNF method includes placing the glass-ceramic article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass-ceramic sample from the normalized detector signal. The maximum CT values are measured using a scattered light polariscope (SCALP) technique known in the art.

In one embodiment of the transparent article 100 (see FIG. 1A), a strengthened substrate 110 can have a surface CS of 200 MPa or greater, 250 MPa or greater, 300 MPa or greater, or 350 MPa or greater. In another implementation, a strengthened substrate can exhibit a residual surface compressive stress (CS) of from about 200 MPa to about 1200 MPa, from about 200 MPa to about 1000 MPa, from about 200 MPa to about 800 MPa, from about 200 MPa to about 600 MPa, from about 200 MPa to about 500 MPa, from about 200 MPa to about 400 MPa, from about 225 MPa to about 400 MPa, from 250 MPa to about 400 MPa, and all CS sub-ranges and values in the foregoing ranges. The strengthened substrate 110 may have a DOL of from 1 μm to 5 μm, from 1 μm to 10 μm, or from 1 μm to 15 μm and/or a central tension (CT) of 50 MPa or greater, 75 MPa or greater, 100 MPa or greater, 125 MPa or greater (e.g., 80 MPa, 90 MPa, or 100 MPa or greater) but less than 250 MPa (e.g., 200 MPa or less, 175 MPa or less, 150 MPa or less, etc.). In such implementations of the transparent articles 100 with substrates 110 having a CT from about 50 MPa to about 200 MPa or 80 MPa to about 200 MPa, the thickness of the substrate 110 should be limited to about 0.6 mm or less to ensure that the substrate is not frangible. For implementations employing thicker substrates, e.g., with a thickness up to 0.8 mm, 0.9 mm, 1.0 mm, 1.1 mm, 1.2 mm, 1.3 mm, 1.4 mm, or even up to 1.5 mm, the upper limit of CT should be held to levels below 200 MPa to ensure that the substrate is not frangible (e.g., 150 MPa for a thickness of 0.8 mm).

The depth of compression (DOC) of the substrate 110 may be from 0.1. (thickness (t) of the substrate) to about 0.25.t, for example from about 0.15·t to about 0.25·t, or from about 0.15.t to about 0.20.t, and all DOC values between the foregoing ranges. For example, the substrate 110 can have a DOC of 20% of the thickness of the substrate, as compared to 15% or less for ion-exchanged glass substrates. In some implementations, the DOC of the substrate 110 can be from about 5 μm to about 150 μm, from about 5 μm to about 125 μm, from about 5 μm to about 100 μm, and all DOC values between the foregoing ranges. In some embodiments, the depths of compression for the substrate materials can range from ˜8% to ˜20% of the thickness of the substrate 110. Note that the foregoing DOC values are as measured from one of the primary surfaces 112 or 114 of the substrate 110. As such, for a substrate 110 with a thickness of 600 μm, the DOC may be 20% of the thickness of the substrate, ˜120 μm from each of the primary surfaces 112, 114 of the substrate 110, or 240 μm in total for the entire substrate 110. In one or more specific embodiments, the strengthened substrate 110 can exhibit one or more of the following mechanical properties: a surface CS of from about 200 MPa to about 400 MPa, a DOL of greater than 30 μm, a DOC of from about 0.08.t to about 0.25.t, and a CT from about 80 MPa to about 200 MPa.

According to embodiments of the disclosure, the substrate 110 (without the optical film structure 120 disposed thereon for measurement purposes) can exhibit a maximum hardness of 8.5 GPa or greater, 9 GPa or greater, or 9.5 GPa or greater (or even greater than 10 GPa in some instances), as measured by a Berkovich Hardness Test over an indentation depth range from 100 nm to about 500 nm in the substrate 110. For example, the substrate 110 can exhibit a maximum hardness of 8.5 GPa, 8.75 GPa, 9 GPa, 9.25 GPa, 9.5 GPa, 9.75 GPa, 10 GPa, and higher hardness levels, as measured by a Berkovich Hardness Test over an indentation depth range from 100 nm to about 500 nm in the substrate 110. Further, substrates 110 of the disclosure can exhibit a Vicker's hardness of greater than 700, or even greater than 800, as measured using a 200 g load. In addition, substrates 110 of the disclosure can exhibit a Mohs hardness of greater than 6.5, or even greater than 7.

As noted earlier, the substrate 110 may be non-strengthened or strengthened, and with a suitable composition to support strengthening. Examples of suitable glass ceramics for the substrate 110 may include a Li₂O—Al₂O₃—SiO₂ system (i.e., an LAS system) glass ceramics, MgO—Al₂O₃—SiO₂ system (i.e., an MAS System) glass ceramics, and/or glass ceramics that include a predominant crystal phase including β-quartz solid solution, β-spodumene ss, cordierite, and lithium disilicate. Such glass-ceramic substrates as substrate 110 may be strengthened using the chemical strengthening processes disclosed herein. In one or more embodiments, MAS-System glass-ceramic substrates may be strengthened in Li₂SO₄ molten salt, whereby an exchange of 2Li⁺ for Mg²⁺ can occur.

According to some embodiments of the transparent article 100 of the disclosure, the substrate 110 may be a glass-ceramic material of an LAS system with the following composition: 69-80% SiO₂, 5-10% Al₂O₃, 10-15% Li₂O, 0.01-1% Na₂O, 0.01-1% K₂O, 0.1-5% P₂O₅ and 0.1-9% ZrO₂ (in wt. %, oxide basis). In some implementations of the transparent article 100 of the disclosure, the substrate 110 may be an LAS system with the following composition: 69-80% SiO_{2, 5}-10% Al₂O₃, 10-15% Li₂O, 0.01-1% Na₂O, 0.01-1% K₂O, 0.1-5% P₂O₅ and 0.1-9% ZrO₂ (in wt. %, oxide basis). According to another embodiment, the substrate 110 may be an LAS system with the following composition: 69-75% SiO₂, 5-10% Al₂O₃, 10-15% Li₂O, 0.05-1% Na₂O, 0.1-1% K₂O, 1-5% P₂O₅, 2-9% ZrO₂ and 0.1-2% CaO (in wt. %, oxide basis). According to a further embodiment, the substrate 110 can have the following composition: 69-72% SiO₂, 5-8% Al₂O₃, 10-13% Li₂O, 0.05-0.5% Na₂O, 0.1-0.5% K₂O, 1.5-4% P₂O₅, 4-9% ZrO₂ and 0.5-1.5% CaO (in wt. %, oxide basis). More generally, these compositions of the substrate 110 are advantageous for the transparent articles 100 of the disclosure because they exhibit low haze levels, high transparency, high fracture toughness, and high elastic modulus, and are ion-exchangeable.

According to embodiments of the transparent article 100, the substrates 110 as glass-ceramic materials are selected with any of the compositions of the disclosure and further processed to the crystallinity levels of the disclosure to exhibit a combination of high fracture toughness (e.g., greater than 1 MPa·√m) and high elastic modulus (e.g., greater than 100 GPa). These mechanical properties can be derived from the presence of the crystalline phase (e.g., the lithium disilicate phase), which exhibits a relatively high modulus; and the microstructure of the final substrate 110, which includes some residual glass phase. Notably, the residual glass phase (and its alkali-containing composition) ensures that the substrate 110 can be ion-exchange strengthened to a high level of central tension (CT) (e.g., greater than 80 MPa) and compressive stress (CS) (e.g., greater than 200 MPa). Further, the ceramming (i.e., the post-melt processing, heat treatment conditions) can be chosen to minimize the grain size of the substrate 110 such that the grain size is smaller than the wavelength of visible light, thereby ensuring that the substrate 110 and article 100 is transparent or substantially transparent. Ultimately, the composition and processing of the substrate 110 as comprising a glass-ceramic material is advantageously selected to achieve a balance of high fracture toughness, high elastic modulus and optical transparency to ensure that the transparent article 100, as employing these substrates 110 and an optical film structure 120, exhibits this balance of mechanical and optical properties, along with a surprising level of damage resistance.

The substrate 110 according to one or more embodiments can have a physical thickness ranging from about 100 μm to about 5 mm in various portions of the substrate 110. Example substrate 110 physical thicknesses range from about 100 μm to about 500 μm (e.g., 100, 200, 300, 400 or 500 μm), from about 500 μm to about 1000 μm (e.g., 500, 600, 700, 800, 900 or 1000 μm), and from about 500 μm to about 1500 μm (e.g., 500, 750, 1000, 1250, or 1500 μm), for example. In some implementations, the substrate 110 may have a physical thickness greater than about 1 mm (e.g., about 2, 3, 4, or 5 mm). In one or more specific embodiments, the substrate 110 may have a physical thickness of 2 mm or less, or less than 1 mm. The substrate 110 may be acid polished or otherwise treated to remove or reduce the effect of surface flaws.

With regard to the hardness of the transparent articles 100 depicted in FIG. 1A, typically, in nanoindentation measurement methods (such as by using a Berkovich indenter) where the coating is harder than the underlying substrate, the measured hardness may appear to increase initially due to development of the plastic zone at shallow indentation depths (e.g., less than 25 nm or less than 50 nm) and then increases and reaches a maximum value or plateau at deeper indentation depths (e.g., from 50 nm to about 500 nm or 1000 nm). Thereafter, hardness begins to decrease at even deeper indentation depths due to the effect of the underlying substrate. Where a substrate 110 having a greater hardness compared to the optical film structure 120 is utilized, the same effect can be seen; however, the hardness increases at deeper indentation depths due to the effect of the underlying substrate.

With further regard to the transparent articles 100 depicted in FIG. 1A, the indentation depth range and the hardness values at certain indentation depth ranges can be selected to identify a particular hardness response of the optical film structure 120 and the layers of the outer and inner structures 130a, 130b thereof, described herein, without the effect of the underlying substrate 110. When measuring hardness of the optical film structure 120 (when disposed on a substrate 110) with a Berkovich indenter, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate 110. The influence of the substrate 110 on hardness occurs at deeper indentation depths (i.e., typically at depths greater than about 10% of the total thickness of the optical film structure 120). Moreover, a further complication is that the hardness response requires a certain minimum load to develop full plasticity during the indentation process. Prior to that certain minimum load, the hardness shows a generally increasing trend.

At small indentation depths (which also may be characterized as small loads) (e.g., up to about 50 nm) in the optical film structure 120, the apparent hardness of a material appears to increase dramatically versus indentation depth. This small indentation depth regime does not represent a true metric of hardness but, instead, reflects the development of the aforementioned plastic zone, which is related to the finite radius of curvature of the indenter. At intermediate indentation depths, the apparent hardness approaches maximum levels. At deeper indentation depths, the influence of the substrate 110 becomes more pronounced as the indentation depths increase. Hardness may begin to drop dramatically once the indentation depth exceeds about 30% of the optical coating thickness.

In one or more embodiments, the transparent article 100, as depicted in FIG. 1A, may exhibit a maximum hardness that is greater than about 8 GPa, 10 GPa, 12 GPa, or greater than 14 GPa (e.g., 14.5 GPa), as measured from the outer surface 120a of the optical film structure 120 by a Berkovich Indenter Hardness Test, which is indicative of high shallow hardness. In one or more embodiments, the transparent article 100, as depicted in FIG. 1A, may exhibit a hardness that is greater than about 6 GPa, 6.5 GPa, 7 GPa, 8 GPa, or greater than 9 GPa, at an indentation depth of from 20 nm to 40 nm (e.g., 7.2 GPa at 20 nm, and 8.8 GPa at 40 nm), as measured from the outer surface 120a of the optical film structure 120 by a Berkovich Indenter Hardness Test, which is indicative of high shallow hardness. In one or more embodiments, the transparent article 100, as depicted in FIG. 1A, may exhibit a hardness that is greater than about 8 GPa, 9 GPa, 10 GPa, 11 GPa, or greater than 11.5 GPa (e.g., 11.9 GPa), at an indentation depth of 100 nm, as measured from the outer surface 120a of the optical film structure 120 by a Berkovich Indenter Hardness Test, which is indicative of high shallow hardness. In one or more embodiments, the transparent article 100, as depicted in FIG. 1A, may exhibit a hardness that is greater than about 8 GPa, 9 GPa, 10 GPa, 11 GPa, 12 GPa, or greater than 12.5 GPa (e.g., 12.7 GPa), at an indentation depth of 125 nm, as measured from the outer surface 120a of the optical film structure 120 by a Berkovich Indenter Hardness Test, which is indicative of high shallow hardness.

Referring again to the transparent article 100, as depicted in FIG. 1A, the design strategy for these articles of using a combination of high RI layers 130B and medium RI layers 130C in the outer structure 130a of the optical film structure 120, as well as minimizing the amount of low RI material in the outer structure 130a, is correlated to achieving these high shallow hardness values. While a certain amount of low RI material may be required to achieve certain low reflectance levels, the amount of low RI material can be reduced by replacing some of the low RI material with medium RI material, which increases the shallow hardness and maximum hardness of the optical film structure 120 as well as the overall transparent article 100 with its optical film structure 120. The use of medium RI layers 130C in the outer structure 130a also contributes to increasing the maximum hardness of the optical film structure 120 while allowing for a lower total thickness of the optical film structure 120. In embodiments, the combination of maximum hardness of greater than 14 GPa, photopic average reflectance of less than 1%, and 940 nm reflectance of less than 3% is achieved using a total optical film structure thickness of less than 2000 nm, which is correlated to the design strategy of using high and medium refractive index layers 130B and 130C, respectively, in the outer structure 130a of the optical film structure 120.

In one or more embodiments of the disclosure, the transparent article 100, as depicted in FIG. 1A and with a substrate 110 comprising a glass-ceramic material, exhibits an average failure stress level of 500 MPa or greater, 600 MPa or greater, 700 MPa or greater, 750 MPa or greater, 800 MPa or greater, or even 850 MPa or greater, as measured in an ROR Test with the outer surface 120a of the optical film structure 120 of these articles placed in tension. Essentially, these article-level average failure stress levels are indicative of transparent articles 100 with optical film structures 120 that have not experienced any loss, or have not experienced any substantial loss, in failure strength relative to the strength of their bare glass-ceramic substrates. In some embodiments, the transparent article 100 exhibits an average failure stress level of 500 MPa, 550 MPa, 600 MPa, 650 MPa, 700 MPa, 725 MPa, 750 MPa, 775 MPa, 800 MPa, 825 MPa, 850 MPa, 875 MPa, 900 MPa, 925 MPa, 950 MPa, 975 MPa, 1000 MPa, 1025 MPa, 1050 MPa, 1075 MPa, 1100 MPa, and all average failure stress levels between the foregoing values, as measured in an ROR Test with the outer surface 120a of the optical film structure 120 of the article placed in tension.

Referring again to the transparent articles 100 (see FIG. 1A) with average ROR failure stress levels of 700 MPa or greater, it should be understood that these failure stress levels can be achieved through the control of the composition, arrangement and/or processing of the optical film structures 120 employed in the transparent articles 100. Notably, the composition, arrangement and/or processing of the optical film structures 120 can be adjusted to obtain residual compressive stress levels of at least 700 MPa (e.g., from 700 to 1100 MPa) and a maximum elastic modulus of at least 120 GPa, as well as a maximum elastic modulus of less than 200 GPa (e.g., from 120 to 200 GPa, from 140 to 200 GPa, from 140 to 170 GPa, or from 140 to 180 GPa). In some cases, it is useful to quantify the elastic modulus of the optical film structure 120 at a depth equal to 15% of the total thickness of the optical film structure 120 to more accurately compare the modulus of the optical film structure 120 for different thicknesses. Using this metric, the preferred range of elastic modulus at a depth equal to 15% of the total thickness of the optical film structure 120 can be adjusted to the range of 120 to 200 GPa, 120 to 180 GPa or 120 to 160 GPa. These mechanical properties of the optical film structures 120 correlate to average failure stress levels of 500 MPa or greater, 600 MPa or greater, or 700 MPa or greater in the transparent articles 100 employing these optical film structures, as measured in an ROR Test with the outer surface 120a of the optical film structure of the article placed in tension.

With further regard to the residual compressive stress and elastic modulus levels (along with hardness levels) of the optical film structure 120, these properties can be controlled through adjustments to the stoichiometry and/or thicknesses of the low RI layers 130A, high RI layers 130B, medium RI layers 130C, capping layer 131 and scratch-resistant layer 150. In embodiments, the residual compressive stress and elastic modulus levels (and hardness levels) exhibited by the optical film structure 120 can be controlled through adjustments to the processing conditions for sputtering the layers of the optical film structure 120, particularly its high RI layers 130B, medium RI layers 130C and scratch-resistant layer 150. In some implementations, for example, a reactive sputtering process can be employed to deposit high RI layers 130B and/or medium RI layers 130C comprising a silicon-containing nitride or a silicon-containing oxynitride. Further, these high RI layers 130B and/or medium RI layers 130C can be deposited by applying power to a silicon sputter target in a reactive gaseous environment containing argon gas (e.g., at flow rates from 50 to 150 sccm), nitrogen gas (e.g., at flow rates from 200 to 250 sccm) and oxygen gas, with residual compressive stress and elastic modulus levels largely dictated by the selected oxygen gas flow rate. For example, a relatively low oxygen gas flow rate (e.g., 45 sccm) can be employed according to the foregoing argon and nitrogen gas flow conditions to produce high RI layers 130B and/or medium RI layers 130C with a SiOₓN_{y} stoichiometry such that its optical film structure 120 exhibits a residual compressive stress of about 942 MPa, hardness of 17.8 GPa and an elastic modulus of 162.6 GPa. As another example, a relatively high oxygen gas flow rate (e.g., 65 sccm) can be employed according to the foregoing argon and nitrogen gas flow conditions to produce high RI layers 130B and/or medium RI layers 130C with a SiOₓN_{y} stoichiometry such that the optical film structure 120 exhibits a residual compressive stress of about 913 MPa, hardness of 16.4 GPa and an elastic modulus of 148.4 GPa. Accordingly, the stoichiometry of the optical film structure 120, particularly its high RI layers 130B, medium RI layers 130C and scratch resistant layer 150, can be controlled to achieve targeted residual compressive stress and elastic modulus levels, which correlate to the advantageously high average failure stress levels in the transparent articles 100 (e.g., greater than or equal to 700 MPa).

According to embodiments, the transparent articles 100 depicted in FIG. 1A may exhibit an average two-sided or two-surface (i.e., through both primary surfaces 112, 114 of the substrate 110) photopic average transmittance, or average visible transmittance, over an optical wavelength regime from 400 to 700 nm, of about 85% or greater, about 88% or greater, about 90% or greater, about 91% or greater, about 92% or greater, about 93% or greater, or even about 94% or greater (e.g., 94.1%) at normal incidence, from 0 to 10 degrees, from 0 to 20 degrees, or even from 0 to 25 degrees. In some embodiments, the transparent articles 100 can exhibit an average two-sided transmittance in the infrared spectrum (e.g., at 940 nm) of about 85% or greater, about 88% or greater, about 90% or greater, about 91% or greater, about 92% or greater, about 93% or greater, or even about 94% (e.g., 94.35% at 940 nm) or greater at normal incidence, from 0 to 10 degrees, from 0 to 20 degrees, or even from 0 to 25 degrees.

According to embodiments, the transparent articles 100 depicted in FIG. 1A may exhibit an average single-sided or first-surface (i.e., through one of the primary surfaces 112, 114 of the substrate 110) photopic reflectance, or average reflectance over an optical wavelength regime from 400 to 700 nm through one or both primary surfaces of the substrate 110 (i.e., first-surface or a two-surface reflectance), of less than about 2%, less than about 1.5%, less than 1%, less than 0.95%, less than 0.9%, or even less than 0.85% (e.g., 0.84%), at normal incidence, near-normal incidence) (˜8°, or from 0 to 10 degrees. The transparent articles 100 may exhibit an average single-sided or first-surface (i.e., through one of the primary surfaces 112, 114 of the substrate 110) photopic reflectance, or average reflectance over an optical wavelength regime from 400 to 700 nm through one or both primary surfaces of the substrate 110 (i.e., first-surface or a two-surface reflectance), of less than 1%, less than 0.95%, or even less than 0.9%, as measured from 0 to 10 degrees, 0 to 20 degrees, 0 to 30 degrees, or even 0 to 35 degrees angle of incidence.

According to embodiments, the transparent articles 100 depicted in FIG. 1A may exhibit an average single-sided or first-surface (i.e., through one of the primary surfaces 112, 114 of the substrate 110) reflectance, or average reflectance at an infrared wavelength (e.g., at 940 nm) or infrared wavelength range (e.g., 900-950 nm)), of less than about 3%, less than about 2.5%, less than about 2%, less than about 1.9%, less than 1.8%, or even less than 1.7% (e.g., 1.66%), at normal incidence, near-normal incidence) (˜8°, or from 0 to 10 degrees.

According to some implementations, the transparent articles 100 depicted in FIG. 1A may exhibit a first-surface reflected color with a D65 illuminant from −6 to +6, −4 to +4, −4 to +2, or −3 to +2 in a* (e.g., −2.1 to +1.0), and −12 to +6, −10 to +4, −8 to +4, −6 to +4, or −5 to +3, in b* (e.g., −4.2 to +2.6), as measured over all incidence angles from 0 to 90 degrees. For example, the transparent articles 100 can exhibit a first-surface reflected color of −4, −3.5, −3.0, −2.5, −2.0, −1.5, −1.0, −0.5, 0, +0.5, +1.0, +1.5, +2.0, +2.5, +3.0, +3.5, +4.0, and all values therebetween, in a*, and −10, −9, −8, −7, −6, −5, −4, −3, −2, −1, 0, +1, +2, +3, +4, and all values therebetween, in b*.

According to some implementations, the transparent articles 100 depicted in FIG. 1A may exhibit a first-surface (i.e., through one of the primary surfaces 112, 114 of the substrate 110), reflected color with a D65 illuminant, as given by √(a*²+b*²), of less than 15, less than 12.5, less than 12, less than 10, less than 8.5, less than 8, less than 7, or even less than 6.5, as measured at normal incidence, from 0 to 10 degrees, or over all incidence angles from 0 to 90 degrees. For example, the transparent articles 100 can exhibit a reflected color of less than 15, 14, 13, 12, 11, 10, 9, 8.5, 8, 7, 6.5, 6, 5, 4, 3.75, 3.5, 3.25, 3, 2.75, 2.5, 2.25, 2, 1.9, 1.8, 1.7, 1.75, 1.6, 1.5, 1.4, 1.3, 1.25, 1.2, 1.1, 1, or even lower, as measured at normal incidence, from 0 to 10 degrees, or over all incidence angles from 0 to 90 degrees.

According to some implementations, the transparent articles 100 depicted in FIG. 1A may exhibit color and reflectance uniformity associated with variations in thickness of the optical film structure 120 that results from line-of-sight layer, film and optical structure deposition methods together with non-planar portions of the substrate 110, e.g., as associated with substrates 110 having flat, angled, or curved regions. In particular, these transparent articles 100 can exhibit a color shift in first-surface reflectance and/or two-surface transmittance, as given by √(a*²+b*²), of less than 15, less than 12.5, less than 10, less than 8, less than 7, or even less than 6.5, as measured for optical film structure thickness scaling factors that range from 70 to 100%, 75 to 100%, 80 to 100%, 85 to 100%, 90 to 100%, or 95 to 100%. Further, according to some embodiments, the transparent articles 100 can exhibit a color shift in first-surface reflectance and/or two-surface transmittance, as given by √(a*²+b*²), of less than 15, less than 12.5, less than 10, less than 8, less than 7, or even less than 6.5, as measured for optical film structure thickness scaling factors that range from 70 to 100%, 75 to 100%, 80 to 100%, 85 to 100%, 90 to 100%, or 95 to 100%, for all incident angles from 0 to 90 degrees or between two angles of incidence, e.g., where the first angle is selected from the range of 0-20 degrees and the second angle is selected from the range of 45-90 degrees.

According to embodiments, the transparent articles 100 depicted in FIG. 1A may exhibit an average single-sided or first-surface (i.e., through one of the primary surfaces 112, 114 of the substrate 110) photopic reflectance, or average reflectance over an optical wavelength regime from 400 to 700 nm through one or both primary surfaces of the substrate 110 (i.e., first-surface or a two-surface reflectance), of less than about 2%, less than about 1.5%, less than 1%, less than 0.95%, or even less than 0.9%, as measured for optical film structure thickness scaling factors that range from 70 to 100%, 75 to 100%, 80 to 100%, 85 to 100%, 90 to 100%, or 95 to 100%.

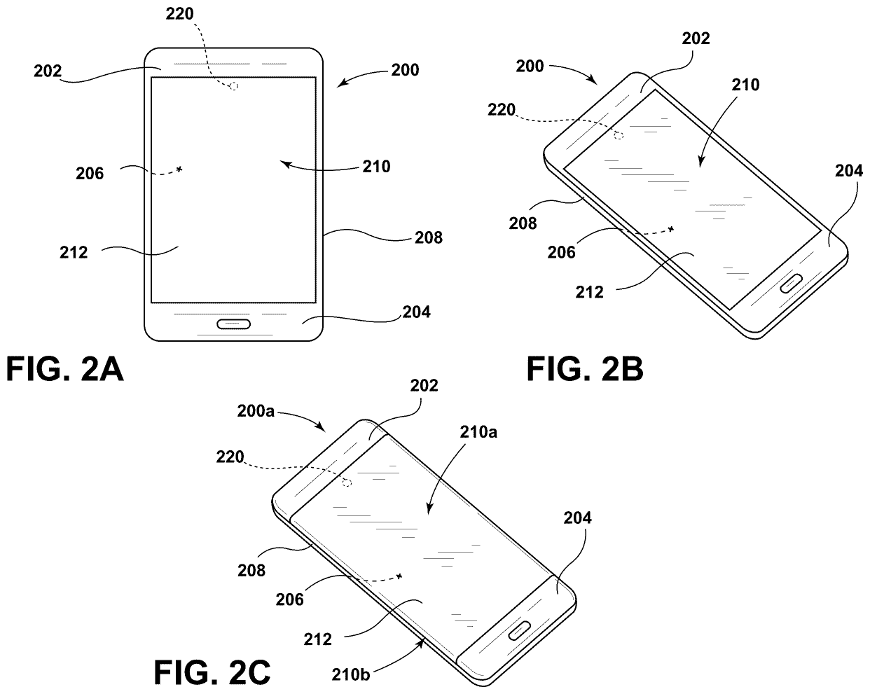

Embodiments of the disclosure also include transparent articles 100 having a range of part surface angles (part surface curvature) that are combined with an optical film structure 120 in which the structure 120 is designed to be robust to thinning of the film structure that occurs from various coating deposition processes (see FIG. 2C, described below). The net result is a transparent article 100 having a range of part surface curvature angles with an optical film structure 120 having controlled hardness, reflectance, color, and color shift with viewing angle over the entire surface of the article 100, including a portion or all of the curved or faceted regions. In addition to absolute levels of hardness, reflectance, and color that meet certain targets, the transparent articles 100 can also exhibit small changes in these values, particularly small changes in visible reflectance and color, when the thickness of the optical film structure 120 is reduced by a scaling factor corresponding to the actual reduction in coating thickness that occurs in an industrially-scalable reactive sputtering process on a manufactured part with surface curvature angles from 0 to 90 degrees. In embodiments, optical film structure thickness scaling factors that range from 70 to 100%, 75 to 100%, 80 to 100%, 85 to 100%, 90 to 100%, or 95 to 100% may correlate to different optical film structure thicknesses created in different regions of a transparent article 100 having a curved or faceted shape with a range of part surface angles from 0 to 10 degrees, 0 to 20 degrees, 0 to 30 degrees, 0 to 40 degrees, 0 to 50 degrees, 0 to 60 degrees, 0 to 70 degrees, 0 to 80 degrees, or 0 to 90 degrees (see FIG. 2C).

An important piece of understanding to create optimal optical film structure designs for a transparent article 100 (see FIG. 1A) with surface curvature, is an understanding of the particular coating process used to form the layers of the optical film structure 120, and the level of line-of-sight coating effects that occur in that process. Some coating deposition processes have no line of sight behavior at all, such as atomic layer deposition, where one monolayer of molecules or atoms is deposited at a time. However, this process can be slow (at least as limited by current processing technology) and is typically too expensive for applications involving large substrates or industries that are cost sensitive, such as the consumer electronics and automotive industries. A more cost-effective process for forming the optical film structure 120, reactive sputtering, is readily scalable to large areas and can be relatively low cost. However, the nature of industrial reactive sputtering processes generally includes a deposition that has at least some line-of-sight character, meaning that the surfaces of the article directly facing the sputtering targets will receive more deposited material (resulting in a thicker coating), while surfaces of the article tilted at some angle relative to the sputtering targets (e.g., its curved surfaces) will generally receive less material, resulting in a thinner coating.

Accordingly, embodiments of the disclosure include transparent articles 100 (see FIG. 1A) in which the optical film structure 120 has been optimized with regard to the tradeoffs between hardness, reflectance, color, and number of coating layers. Adding an arbitrary number of layers to achieve an optical target (e.g., without consideration to hardness or other mechanical properties) in the optical coating will tend to reduce the hardness of the coating to levels below the required range for applications targeting scratch-resistant chemically strengthened glass for consumer electronics, automotive, and touch screen applications (e.g., to a hardness <<8 GPa, as measured by Berkovich Indenter Hardness Test at an indentation depth of about 100 nm or greater). In the case of transparent articles 100 having curved surfaces, it can be important to assess how part surface curvature relates to the amount, or scale factor, by which the layers of the optical film structure 120 will be reduced or thinned from their target design thicknesses. The target design thickness (or the thickness at 100% scale factor or 1.0 scale factor) is generally the thickness that is coated on the “flat” areas of the article 100, those portions of the article 100 that are closest to directly facing the sputtering targets, or those portions of the article 100 that receive the most material from the sputtering targets. Any part of the article 100 that is curved away from this maximum thickness deposition direction will generally receive less material, resulting in a thinner coating on these curved areas as each of the layers of the optical film structure 120 is formed. For optimal optical coating design for the optical film structure 120 of embodiments of the articles 100 (see FIG. 1A), it can be beneficial to understand the design window in terms of target part curvature, as well as how part curvature corresponds to coating thinning in the deposition process. This can enable optical design of the optical film structure 120 in such a way that optimizes, for example, reflectance and color over the target range of part angles and coating thickness variation, without sacrificing too much in terms of the hardness of the coating, number of layers in the coating, or other metrics. Said another way, without an understanding of the relevant window of part angles and coating thickness scale factors, one can over-design the coating to include too many layers to achieve a desired set of optical properties, thus sacrificing hardness and scratch resistance.

Referring generally to the transparent article 100 depicted in FIG. 1A, the optical film structures 120 of these articles exhibit high hardness at shallow depths. Further, these optical film structures 120 employ one or more medium RI layers 130C (e.g., n=1.5 to 1.9, SiOₓN_{y} material), sometimes in combination with one or more high RI layers 130B (e.g., n=1.9 or greater, SiNₓ), in the outer structure 130a. This strategy tends to enable a minimized use of lower-index materials (e.g., low RI layers 130A) in the optical film structure 120 and the outer structure 130a, which is an important factor in boosting the maximum hardness of the overall optical film structure 120, as well as the hardness measured at shallow indentation depths (as measured from the air-side surface 120a) such as 20 nm, 40 nm, 100 nm, and 125 nm.

Further, in some embodiments of the transparent article 100 depicted in FIG. 1A, the inner structure 130b can comprise a refractive index gradient (not shown in FIG. 1A) rather than, for example, a plurality of low and high RI layers 130A, 130B. Thus, in these embodiments, the transparent article 100 may comprise in order: 1) substrate 110; 2) a refractive index gradient structure as the inner structure 130b; 3) a scratch resistant layer 150; and 4) an outer structure 130a enabling high shallow hardness. The refractive index gradient may be formed by a compositional gradient. In such embodiments, the composition at or adjacent to the substrate primary surface 112 may be tuned to have a refractive index within about 0.05 refractive index units of the refractive index of the substrate 110 itself (e.g., from about 1.45 to 1.55), while the composition at or adjacent to the scratch resistant layer 150 may be tuned to have a refractive index within about 0.1 refractive index units of the refractive index of the scratch resistant layer 150 (e.g., from about 1.65 to 1.95). The thickness of the refractive index gradient region (i.e., as the inner structure 130b) may preferably be in the range from about 100 nm to 500 nm.

In some embodiments of the transparent article 100 depicted in FIG. 1G with an inner structure 130b comprising a refractive index gradient, the gradient is derived from a compositional gradient formed from materials such as Si, Al, N, O, C, and/or combinations thereof. In one or more specific embodiments, the composition gradient is formed from Si, N and/or O. In one example, the refractive index gradient may include an oxygen-content gradient in which the oxygen content decreases or remains constant along the thickness of the refractive index gradient in the direction from the substrate surface to the scratch resistant layer. In yet another example, the refractive index gradient may include a nitrogen-content gradient in which the nitrogen content increases or remains constant along the thickness of the refractive index gradient in the direction from the substrate surface to the scratch resistant layer. In one or more alternative embodiments, the optical film structure 120 may include a density gradient and/or an elastic modulus gradient, in addition to or instead of the refractive index gradient otherwise described herein. In embodiments, an elastic modulus gradient can be utilized to further improve certain mechanical performance aspects of the transparent article 100, such as maintaining or improving retained strength, reducing warp, or reducing delamination.

Referring generally to the transparent articles 100 detailed above and depicted in exemplary form in FIG. 1A, embodiments of these articles employ optical film structures 120 that can possess a significant amount of compressive stress, as deposited in the substrate 110, which can aid in the overall retained strength of the article. On the other hand, the residual compressive stress in the optical film structure 120 can also lead to undesirable warpage to the article 100, necessitating additional processing of the substrate 110 (e.g., asymmetric polishing and material removal) prior to the deposition of the layers that make up the optical film structure 120. That is, some embodiments of the optical film structure 120 are such that some asymmetric removal of material of the substrate 110 (which may be a substrate having surface compressive stress) is required before deposition of the optical film structure 120 to effectively counteract the residual compressive stress of the optical film structure to ensure that the resulting article 100 does not exhibit substantial warpage. In embodiments, the substrate 110 may have a first compressive stress on a first surface and a second compressive stress on a second surface, where the first and second compressive stresses are unequal, or where the integrated compressive stresses over a range of depths adjacent to the first surface and the second surface are unequal. These unequal surface compressive stresses in the substrate 110 can lead to substrate warpage, which can then be balanced (flattened) by deposition of a coating (i.e., an optical film structure 120) with compressive stress on the surface of the substrate 110 having the lower compressive stress. In embodiments where the first surface of the substrate 110 has a lower compressive stress or a lower integrated compressive stress than the second surface, the coating having a compressive stress would preferably be deposited on the first surface of the substrate 110 to reduce or flatten the warpage of the transparent article 100.

Without being bound by theory, it is generally understood that reducing the thickness of the optical film structure 120 can reduce the degree of warpage caused by the optical film structure 120, as deposited on the substrate 110. While some conventional optical film structure designs, such as shown in FIG. 1B (as described in detail below), employ a relatively thick scratch resistant layer (e.g., 2000 nm, SiOₓN_{y}), merely reducing the thickness of these scratch resistant layers with the goal of reduced warpage can significantly and undesirably reduce the hardness of the article. Nevertheless, embodiments of the transparent articles 100 of the disclosure (see, e.g., FIG. 1A) employ optical film structures 120 with outer structures 130a having multiple high RI layers 130B (e.g., SiNₓ) and medium RI layers 130C (e.g., SiOₓN_{y}) in which the outer structure 130a itself provides a significant hardness response. That is, without being bound by theory, these embodiments are configured with less low RI material in the outer structure 130a and the net result is that the outer structure 130a itself has more influence on the hardness response of the transparent article 100. Accordingly, the scratch resistant layer 150 in these transparent articles 100 plays a less substantial role and, therefore, its thickness is advantageously less influential on the hardness response of the article. Hence, embodiments of these articles 100 (e.g., as shown in FIG. 1A) can advantageously employ thinner scratch resistant layers to reduce warpage, while not sacrificing hardness levels and retained strength. In particular, embodiments of the transparent articles 100 of the disclosure (e.g., as shown in FIG. 1A) advantageously can be configured to reduce warpage, while retaining an advantageous combination of strength and hardness, through reductions in the thickness of the scratch resistant layer 150 (e.g., to thicknesses from about 100 nm to less than 2000 nm, from about 500 nm to 1500 nm, from about 750 nm to 1250 nm, etc.) employed in the optical film structure 120. That is, any of the transparent articles 100 of the disclosure can benefit from these concepts with a reduction in the stated thickness of its scratch resistant layer 150.

One benefit of these embodiments is that the reductions to the thickness of the scratch resistant layer 150 means that a lesser amount of material is used in the optical film structure 120, leading to shorter sputter times and associated costs savings and throughput increases. Another benefit is that decreasing the thickness of the scratch resistant layer 150 can maintain or even slightly improve the retained strength of the article 100. Another benefit is that decreasing the thickness of the scratch resistant layer 150 can provide an improvement on the degree of warp observed in the substrate 110 after deposition of the optical film structure 120; consequently, the lower degrees of warp necessitate much less processing (e.g., asymmetric polishing) prior to deposition of the optical film structure 120.

The transparent articles 100 of the disclosure, as depicted in exemplary form in FIG. 1A, are resistant to failure when experiencing drop-related impacts, particularly no measurable reductions, or even an improvement in drop resistance as compared to bare substrates without an optical film structure, as well as no measurable reductions in drop resistance compared to coated articles with thicker optical film structures. As noted earlier, the Drop Test Method involves performing face-drop testing on a puck with a transparent article 100 attached thereto. The transparent article 100 is attached to the puck with tesa® 61385 double sided adhesive tape to hold the article to the puck during the drop test described herein below. The article to be tested has a thickness similar or equal to the thickness that will be used in a given hand-held consumer electronic device, such as 0.5 mm or 0.6 mm. A puck refers to a structure meant to mimic the size, shape, and weight distribution of a given device, such as a cell phone. Hereinafter, the term “puck,” refers to a structure that has a weight of 200 grams, a length of 133 mm, a width of 68 mm, and a height of 9.4 mm. In embodiments, the puck has the dimensions and weight similar to a handheld electronic device.

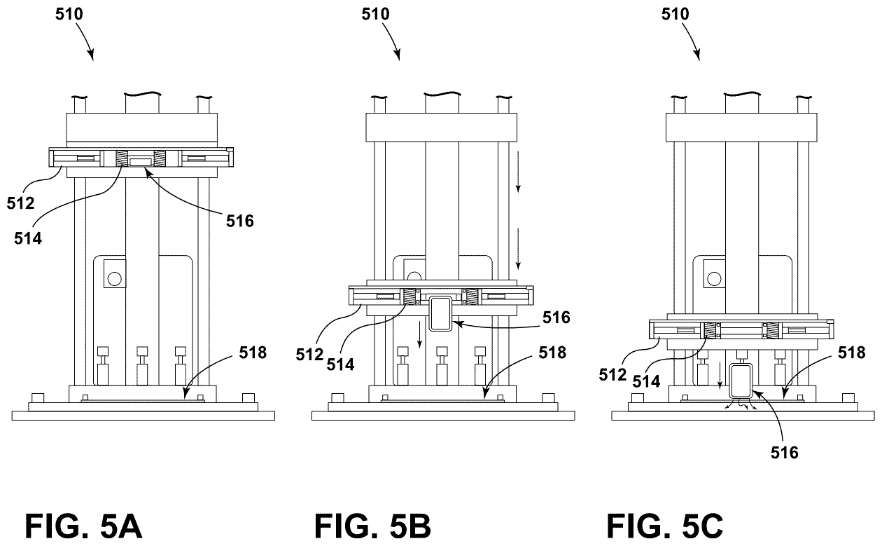

An exemplary device-drop machine that may be used to conduct the Drop Test Method is shown as reference number 510 in FIG. 5A. The device-drop machine 510 includes a chuck 512 having chuck jaws 514. The puck 516 is staged in the chuck jaws 514 with the transparent article 100 (see FIG. 1A) attached thereto and facing downward. The chuck 512 is ready to fall from, for example, an electro-magnetic chuck lifter. Referring now to FIG. 5B, the chuck 512 is released and during its fall, the chuck jaws 514 are triggered to open by, for example, a proximity sensor. As the chuck jaws 514 open, the puck 516 is released. Referring now to FIG. 5C, the falling puck 516 strikes a drop surface 518. The drop surface 518 may be sandpaper, such as 80 grit sandpaper, positioned on a steel plate. If the transparent article 100 attached to the puck survives the fall (i.e., does not crack), the chuck 512 is set at an increased height and the test is repeated. The failure height is then the lowest height from which the puck including the article 100 is dropped and the glass composition fails. A single transparent article 100 is tested at multiple heights, such as at 22 cm, 30 cm, 40 cm, 50 cm, 60 cm, and increments of 10 centimeters until the article 100 fails by showing damage. The sandpaper is replaced upon failure of the glass. Unless otherwise indicated 80 grit sandpaper is used herein.

In one or more embodiments the mean failure height of the transparent article 100 of FIG. 1A may be greater than or equal to 50 cm, such as greater than or equal to 75 cm, greater than or equal to 100 cm, greater than or equal to 125 cm, greater than or equal to 150 cm, greater than or equal to 175 cm, or even greater than or equal to 200 cm. In some embodiments, the mean failure height of the transparent articles 100 is from about 50 cm to about 220 cm, such as from about 50 cm to about 200 cm, from about 50 cm to about 150 cm, from about 50 cm to about 100 cm, from about 100 cm to about 220 cm, from about 100 cm to about 200 cm, from about 100 cm to about 150 cm, from about 150 cm to about 220 cm, from about 150 cm to about 200 cm, from about 200 cm to about 220 cm, or any combination of these ranges. According to an embodiment, the transparent article 100 exhibits a mean failure height of at least 75 cm, 80 cm, or even 85 cm, as measured according to the Drop Test Method with 80 grit garnet sandpaper.

Referring now to FIG. 1B (PRIOR ART), a comparative transparent article 100′ is depicted. As shown in FIG. 1B, the comparative transparent article 100′ has some similarities to the transparent articles 100 of the disclosure (see FIG. 1A and earlier description). For example, the comparative article 100′ includes an optical film structure 120 with an outer structure 130a and inner structure 130b. The optical film structure 120 includes a scratch-resistant layer 150, a plurality of alternating low RI and high RI layers, 130A and 130B, respectively, and a plurality of alternating medium RI and high RI layers, 130C and 130B, respectively. In some embodiments, the inner structure 130a includes a plurality of alternating low RI and high RI layers, 130A and 130B, respectively. The outer structure 130a of the comparative article 100′ is also inclusive of an outermost capping layer 131 (e.g., with a refractive index within the range of those specified for low RI layers 130A).

More specifically, and in contrast to the transparent article 100 shown in FIG. 1A, the comparative transparent article 100′ is configured such that the outer structure 130a includes a total of five (5) alternating layers (i.e., alternating medium and high RI layers 130C and 130B); and the inner structure 130b includes a total of seven (7) layers (i.e., alternating low RI and high RI layers 130A, 130B, respectively). Further, the outer structure 130a of the optical film structure 120 includes a capping layer 131; and the optical film structure 120 includes a scratch-resistant layer 150 disposed between the outer and inner structures 130a and 130b. Accordingly, in the comparative transparent article 100′ depicted in exemplary form in FIG. 1B, the optical structure 120 includes a total of 14 layers.

In general, comparative transparent article 100′ of FIG. 1B exhibits properties and attributes that are suitable for various applications, including those described below in connection with FIGS. 2A-2C, e.g., consumer electronic devices 200. Nevertheless, the transparent article 100, as depicted in exemplary form in FIG. 1A, exhibits an advantageous combination of distinctive structural features, along with mechanical and optical properties, as compared to comparative article 100′, including one or more of the following: an average photopic reflectance of <1%, an average infrared (940 nm) reflectance of <2%, a color shift of less than 15 for all thickness scaling factors from 70-100%, a mean failure height of at least 75 cm according to the Drop Test Method, an optical film structure 120 with a total physical thickness of ≤2000 nm, and an optical film structure 120 with outer structure 130a having a total physical thickness from 400-800 nm and/or at least one medium RI layer 130C with a refractive index from 1.55-1.65.

The transparent articles 100 disclosed herein (e.g., as shown in FIG. 1A) may be incorporated into a device article, for example, a device article with a display (or display device articles) (e.g., consumer electronics, including mobile phones, tablets, computers, navigation systems, wearable devices (e.g., watches) and the like), augmented-reality displays, heads-up displays, glasses-based displays, architectural device articles, transportation device articles (e.g., automotive, trains, aircraft, sea craft, etc.), appliance device articles, or any device that benefits from transparency, scratch resistance, abrasion resistance, damage resistance, or a combination thereof. An exemplary device article incorporating any of the articles disclosed herein (e.g., as consistent with the transparent articles 100 depicted in FIG. 1A) is shown in FIGS. 2A and 2B. Specifically, FIGS. 2A-2C show a consumer electronic device 200 including a housing 202 having a front 204, a back 206, and side surfaces 208; electrical components (not shown) that are at least partially inside or entirely within the housing and including at least a controller, a memory, and a display 210 at or adjacent to the front surface of the housing; and cover substrate 212 at or over the front surface of the housing such that it is over the display. In some embodiments, the cover substrate 212 may include any of the transparent articles 100 disclosed herein.

Referring now to FIG. 2C, a perspective view of an alternative embodiment of the consumer electronic device 200 of FIG. 2A is depicted, namely, a consumer electronic device 200a with a display 210a having a non-planar substrate with curved or faceted edges 210b, according to one or more embodiments of the disclosure. In this embodiment, the transparent articles 100 of the disclosure (see FIG. 1A) are used in the display 210a, and modified such that they have a range of part surface angles (part surface curvature) that are combined with an optical film structure 120 in which the structure 120 is designed to be robust to thinning of the film structure that occurs from various coating deposition processes.

### EXAMPLES

The following examples describe various features and advantages provided by the disclosure, and are in no way intended to limit the invention and appended claims.

In these examples (Ex. 1) and comparative examples (e.g., Comp. Ex. 1, Comp. Ex. 1B), transparent articles were formed according to the methods of the disclosure and as delineated in each of the Tables 1 and 2. More specifically, the optical film structures of these examples, unless otherwise noted, were formed using a metal-mode, reactive sputtering process in a rotary drum coater, with independent control of sputtering power in the metal deposition and the inductively coupled plasma (ICP) (gas reaction) zones. Reactive gases (e.g., N₂ gas and O₂ gas) are isolated from the metal target in the ICP (gas reaction) zone. Further, the metal sputtering zone employs only inert gas flow (i.e., Ar gas).

Optical transmission and reflectance properties were measured on experimental samples prepared according to these examples using an Agilent Cary 5000 UV-Vis-NIR spectrophotometer. Hardness values for the transparent articles reported in the following examples were obtained using the Berkovich Hardness Test method outlined earlier in the disclosure.

More specifically, the inventive examples (Ex. 1), as combined with the strengthened glass substrate, exhibit very high shallow hardness and low reflectance in the visible, IR and near-IR spectra, among other mechanical and optical properties, and as exemplary of the transparent articles 100 of the disclosure (see FIG. 1A and corresponding description). Further, the inventive examples (Ex. 1), as comprising glass or glass-ceramic substrates, exhibit, or are otherwise expected to exhibit, high shallow hardness, low reflectance in the visible, IR and near-IR spectra, minimized optical film structure thickness, and low color shift in reflectance, among other optical and mechanical, e.g., retained strength and drop resistance.

### Example 1

A transparent article including a strengthened glass substrate was prepared for this example with the structure delineated below in Table 1 (e.g., as exemplary of the transparent article 100 of FIG. 1A, as described above). The glass substrate is an ion-exchanged, alkali-aluminosilicate glass having a thickness of 550 μm and a refractive index of 1.506. Further, the glass substrate has the following composition: 64.9 mol % SiO₂; 15.53 mol % Al₂O₃; 0.86 mol % P₂O₅; 3.21 mol % B203; 7.2 mol % Li₂O; 4.78 mol % Na₂O; 0.21 mol % K2O; 0.54 mol % MgO; 0.18 mol % TiO₂; 1.47 mol % CaO; 0.02 mol % Fe₂O₃; 0.01 mol % ZrO₂; 0.04 mol % SnO₂; and 1.07 mol % SrO. After forming, the glass substrate was ion-exchange strengthened using a 2-step ion-exchange process. The first ion-exchange step used a molten salt bath of 50% KNO₃/50% NaNO₃ (wt. %) at 400° C. for 4 hours and 30 minutes. The second ion-exchange step used a molten salt bath of 99% KNO₃/1% NaNO₃ (wt. %) at 390° C. for 15 minutes. Further, the layers of the optical film structure were deposited according to vapor deposition conditions set forth in U.S. Patent Application Publication No. 2020/0158916, the salient portions of which are incorporated herein by reference.

Referring again to the transparent article of this example, the layers (e.g., layers 11-19 in Table 1) of the optical film structure above the scratch resistant layer (e.g., layer 10 in Table 1) are configured to achieve high shallow hardness while not negatively affecting the optical properties of the article, including reflectance in the visible, IR, and near-IR spectra. As is evident from the optical film structure design of Table 1, medium index layers (SiOₓN_{y} layers 11, 13, 15, and 17) are disposed adjacent to high index layers (SiNₓ layers 12, 14, 16 and 18), which drive shallow high hardness levels in the article. Similarly, as is evident in Table 1, the total thickness of the low refractive index layers (e.g., SiO₂ layer 19) in the outer structure of the optical film structure above the scratch-resistant layer is minimized to a level that is less than 125 nm, which also helps drive shallow high hardness levels in the article.

TABLE 1
Ex. 1 transparent article design with strengthened glass substrate

| | | thickness | |
|---|---|---|---|
| Layer | material | (nm) | index (550 nm) |
| | Glass | Substrate | 1.506 |
| 1 | SiO2 | 20 | 1.467 |
| 2 | SiOxNy | 8 | 1.964 |
| 3 | SiO2 | 64 | 1.467 |
| 4 | SiOxNy | 20 | 1.964 |
| 5 | SiO2 | 49.2 | 1.467 |
| 6 | SiOxNy | 35.9 | 1.964 |
| 7 | SiO2 | 26.4 | 1.467 |
| 8 | SiOxNy | 50.6 | 1.964 |
| 9 | SiO2 | 8 | 1.467 |
| 10 | SiOxNy | 1000 | 1.957 |
| 11 | SiOxNy | 8.3 | 1.601 |
| 12 | SiNx | 36.8 | 2.029 |
| 13 | SiOxNy | 39.5 | 1.601 |
| 14 | SiNx | 24.4 | 2.029 |
| 15 | SiOxNy | 102.6 | 1.601 |
| 16 | SiNx | 16.8 | 2.029 |
| 17 | SiOxNy | 52.7 | 1.601 |
| 18 | SiNx | 150.4 | 2.029 |
| 19 | SiO2 | 100.7 | 1.475 |
| Medium | Air | | 1 |

Total thickness (nm): 1814.3
AR layers (outer structure) thickness (nm): 532.2
Low-RI in AR thickness (nm): 101

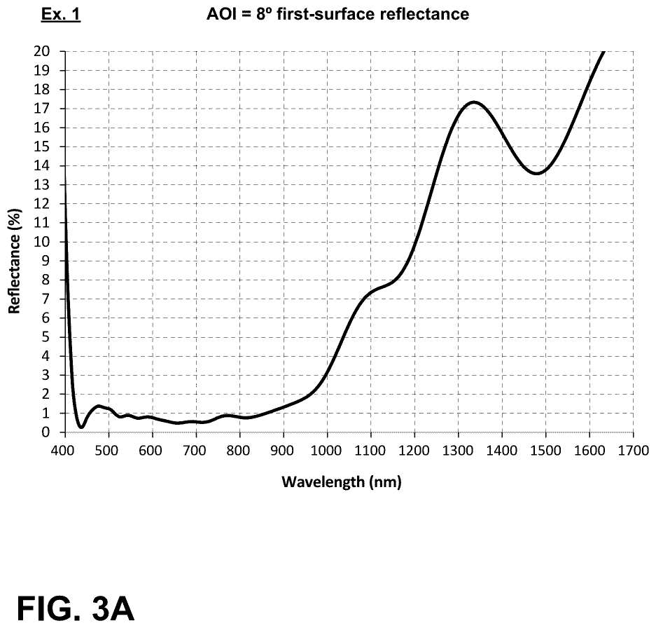

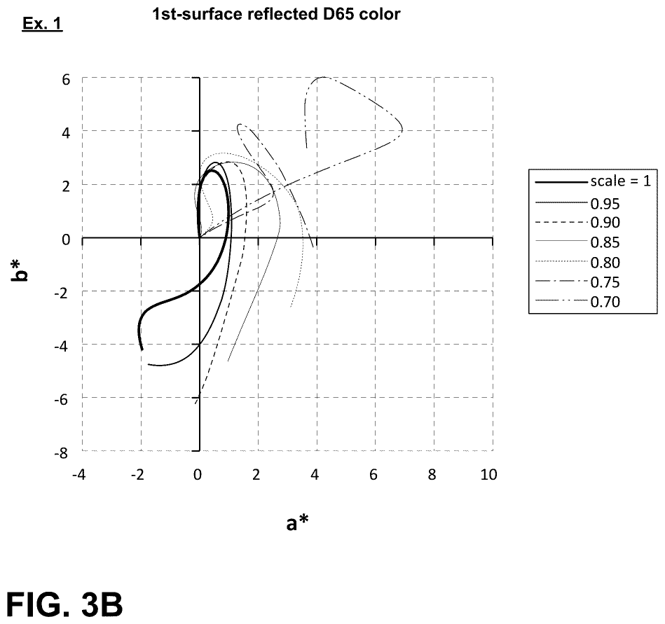

Referring to FIG. 3A, a plot is provided of first-surface reflectance vs. wavelength for this inventive example, as measured at a near-normal incident angle of 6°. Notably, the reflectance observed in the visible wavelength range (400-700 nm) is particularly low, e.g., less than 1.5%.

Referring to FIG. 3B, a plot is provided of single-sided, reflected color for this inventive example, as measured at incident angles from 0° to 90° with optical film structure thickness scaling factors from 70 to 100%. Each curve represents the full range of illumination angles of incidence from 0° to 90°. The different scaling factors represent different optical film structure thickness scaling that may be found on the curved or angled regions of a transparent article with an optical film structure due to vacuum deposition line of sight effects. For this design, the coating color excursions remain less than √(a*²+b*²)=6.5 for all coating thickness scaling factors from 75-100%. For Ex. 1, the maximum 0°-90° color excursion is less than 6.5 for all optical film structure thickness scaling factors from 75-100%, and less than 8.5 for all optical film structure thickness scaling factors from 70-100%.

### Comparative Example 1

A comparative transparent article including a strengthened glass-ceramic substrate was prepared for this example with the structure delineated below in Table 2 (e.g., as exemplary of the comparative transparent article 100′ of FIG. 1B, as described above). The glass-ceramic substrate is an ion-exchanged, LAS glass-ceramic substrate having a thickness of 600 μm and a refractive index of 1.533. Further, the glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

Referring again to the comparative transparent article of this example, the layers (e.g., layers 9-14 in Table 2) of the optical film structure above the scratch resistant layer (e.g., layer 8 in Table 2) are configured to achieve high shallow hardness while not negatively affecting the optical properties of the article, including reflectance in the visible, IR, and near-IR spectra. As is evident from the optical film structure design of Table 2, medium index layers (SiOₓN_{y} layers 9, 11, and 13) are disposed adjacent to high index layers (SiN_{y} layers 10 and 12), which drive shallow high hardness levels in the article. Similarly, as is evident in Table 13, the total thickness of the low refractive index layers (e.g., SiO₂ layer 14) in the outer structure of the optical film structure above the scratch-resistant layer is minimized to a level that is less than 75 nm, which also helps drive shallow high hardness levels in the article.

TABLE 2
Comp. Ex. 1 transparent article with
strengthened glass-ceramic substrate

| | | thickness | |
|---|---|---|---|
| Layer | material | (nm) | index (550 nm) |
| | Glass-Ceramic | Substrate | 1.533 |
| 1 | SiO2 | 25.0 | 1.476 |
| 2 | SiOxNy | 14.0 | 1.829 |
| 3 | SiO2 | 51.2 | 1.476 |
| 4 | SiOxNy | 30.7 | 1.829 |
| 5 | SiO2 | 30.1 | 1.476 |
| 6 | SiOxNy | 49.2 | 1.829 |
| 7 | SiO2 | 8.9 | 1.476 |
| 8 | SiOxNy | 2000 | 1.829 |
| 9 | SiOxNy | 14.6 | 1.744 |
| 10 | SiNy | 15.1 | 2.058 |
| 11 | SiOxNy | 25.9 | 1.744 |
| 12 | SiNy | 125.7 | 2.058 |
| 13 | SiOxNy | 42.6 | 1.589 |
| 14 | SiO2 | 60.0 | 1.476 |
| | Medium | Air | 1 |

Total thickness (nm): 2492.9
AR layers (outer structure) thickness (nm): 283.9
Low-RI in AR thickness (nm): 60.0

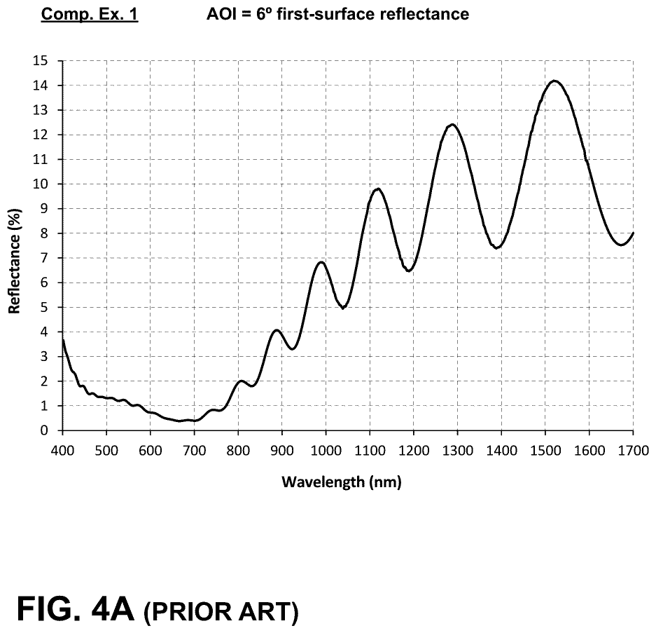

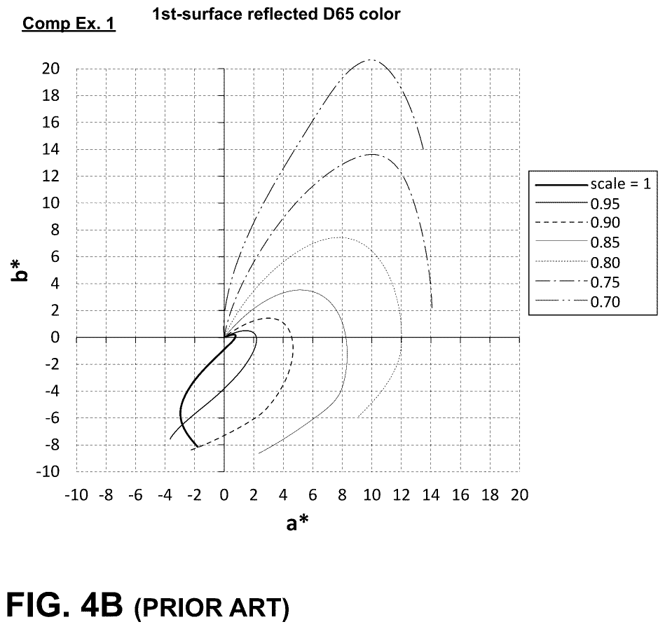

Referring to FIG. 4A, a plot is provided of first-surface reflectance vs. wavelength for this comparative example (Comp. Ex. 1), as measured at a near-normal incident angle of 6°. Notably, this comparative example exhibits a substantially higher reflectance in the visible (400-700 nm) and near IR (700-1000 nm) wavelength regimes as compared to the inventive example, Ex. 1.

Referring to FIG. 4B, a plot is provided of single-sided, reflected color for this comparative example (Comp. Ex. 1), as measured at incident angles from 0° to 90° with optical film structure thickness scaling factors from 70 to 100%. Each curve represents the full range of illumination angles of incidence from 0-90°. The different scaling factors represent different optical film structure thickness scaling that may be found on the curved or angled regions of a transparent article with an optical film structure due to vacuum deposition line of sight effects. For this comparative design, the optical film structure color excursions are greater than √(a*²+b*²)=6.5 for all coating thickness scaling factors from 70-100%. Therefore, there is not any practical optical film structure thickness scaling for this design that enables a 0-90° color range less than 6.5, which stands in contrast with the prior inventive example (Ex. 1). For Comp. Ex. 1, the maximum 0-90° color excursion is approximately: greater than 8 for thickness scaling factors from 90-100%; greater than 11 for thickness scaling factors from 80-100%; greater than 16 for thickness scaling factors from 75-100%, and greater than 22 for thickness scaling factors from 70-100%.

In addition, as detailed below, Table 3 below provides a summary of selected optical and mechanical properties of Ex. 1 and Comp. Ex. 1. Of particular note is that Ex. 1 has a lower 1^{st} surface photopic average reflectance than Comp. Ex. 1, 0.84% for Ex. 1 vs. 1.06% for Comp. Ex. 1. In addition, Ex. 1 has a 1^{st} surface reflectance at 940 nm of 1.66% vs. 3.84% for Comp. Ex. 1. This lower infrared reflectance is correlated to less change in reflectance and color over a wider range of coating thickness scaling factors. Ex. 1 also has a lower total thickness, 1814 nm vs. 2493 nm for Comp. Ex. 1.

TABLE 3
Summary of Optical and Mechanical
Properties of Ex. 1 and Comp. Ex. 1

| | Comp. Ex. 1 | Ex. 1 |
|---|---|---|
| 1^{st}-surface average photopic reflectance (%) | 1.06 | 0.84 |
| (6° AOI) | | |
| % R (@940 nm) | 3.84 | 1.66 |
| % R (@1500 nm) | 13.81 | 13.5 |
| % R (@1200-1500 nm) | 10.07 | 14.60 |
| % R (@1000-1700 nm) | 9.45 | 13.30 |
| Number of layers in optical film structure | 14 | 19 |
| Total thickness of optical film structure (nm) | 2493 | 1814 |
| Scratch Resistant layer thickness (nm) | 2000 | 1000 |
| Scratch resistant layer index (@550 nm) | 1.83 | 1.957 |
| Outer structure thickness: (nm) | 283.9 | 532.2 |
| % SiNₓ in outer structure layers | 49.6% | 42.9% |
| Low-n material in outer structure (not capping) | 1.74/1.59 | 1.60 |
| Total low-RI material (e.g., SiO₂) | 60 | 101 |
| in outer structure (nm) | | |
| Capping layer thickness (SiO₂) | 60 | 101 |
| SiO₂ index (550 nm) | 1.476 | 1.475 |
| Thickness scaling range (0-90° AOI) 1^{st} surface | None | 75-100% |
| reflected color shift √(a*² + b*²) <6.5 | | |
| Modeled Hardness 20 nm (GPa) | 7.8 | 7.2 |
| Modeled Hardness 40 nm (GPa) | 10 | 8.8 |
| Modeled Hardness 100 nm (GPa) | 14.6 | 11.9 |
| Modeled Hardness 125 nm (GPa) | 15.6 | 12.7 |
| Modeled Hardness 500 nm (GPa) | 17.2 | 14.3 |
| Modeled Maximum Hardness (GPa) | 17.6 | 14.5 |

### Drop Test Performance

In this example, the Drop Test Method was used to test to evaluate transparent articles of the present disclosure (Ex. 1) in view of a bare, uncoated glass substrate control (Comp. Ex. 1A, i.e., same substrate as in Ex. 1) and a comparative transparent article using the same glass substrate with a substantially thicker optical film structure (Comp. Ex. 1B, see Table 4 below).

TABLE 4
Comp. Ex. 1B transparent article design
with strengthened glass substrate

| | | thickness | Index |
|---|---|---|---|
| Layer | Material | (nm) | (550 nm) |
| | Glass | Substrate | 1.51 |
| 1 | SiO2 | 20 | 1.476 |
| 2 | SiOxNy | 8.14 | 1.943 |
| 3 | SiO2 | 67.12 | 1.476 |
| 4 | SiOxNy | 21.57 | 1.943 |
| 5 | SiO2 | 50.82 | 1.476 |
| 6 | SiOxNy | 39.32 | 1.943 |
| 7 | SiO2 | 26.68 | 1.476 |
| 8 | SiOxNy | 56.09 | 1.943 |
| 9 | SiO2 | 8 | 1.476 |
| 10 | SiOxNy | 1500 | 1.943 |
| 11 | SiO2 | 14.56 | 1.476 |
| 12 | SiNy | 38.39 | 2.014 |
| 13 | SiO2 | 46.3 | 1.476 |
| 14 | SiNy | 25.19 | 2.014 |
| 15 | SiO2 | 81.14 | 1.476 |
| 16 | SiNy | 24.93 | 2.014 |
| 17 | SiO2 | 44.65 | 1.476 |
| 18 | SiNy | 152.62 | 2.014 |
| 19 | SiO2 | 102.28 | 1.476 |
| | Medium | Air | 1 |

Total thickness (nm): 2327.8
AR layers (outer structure) thickness (nm): 530.1
Low-RI in AR thickness (nm): 288.9

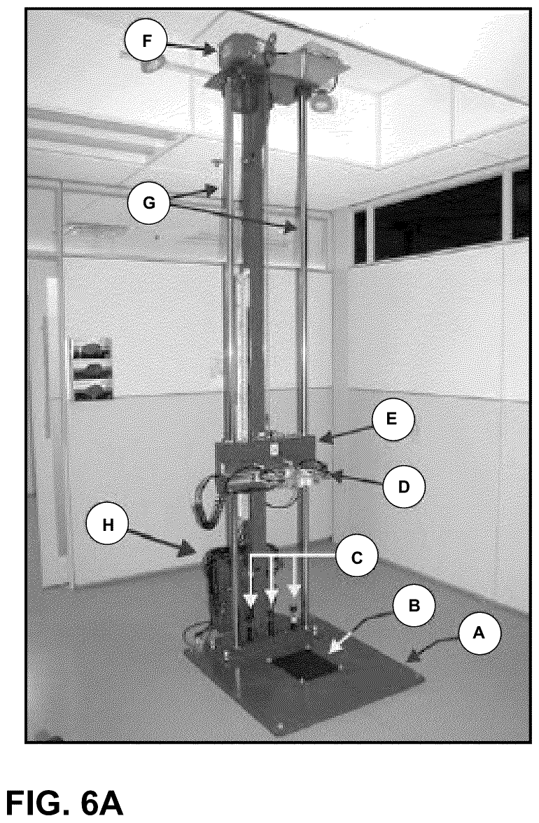

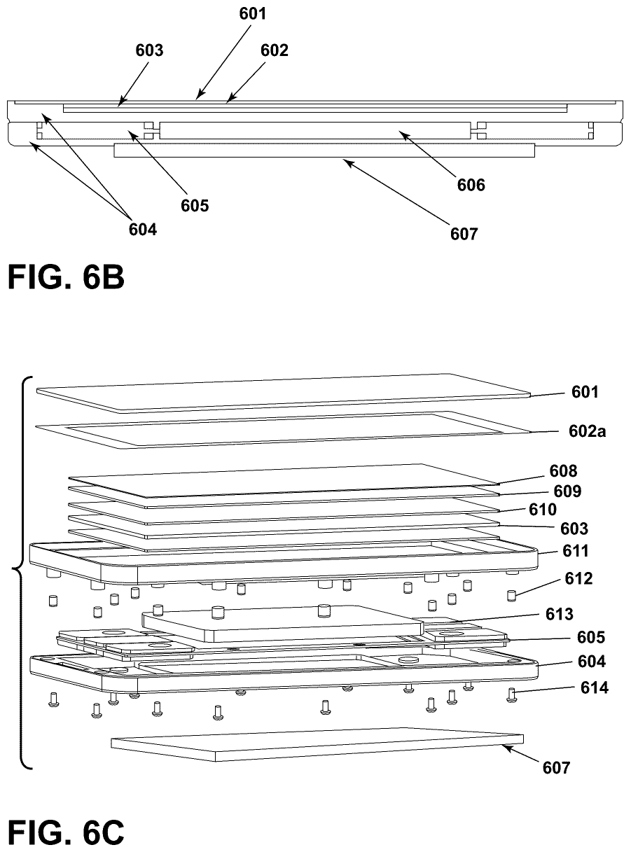

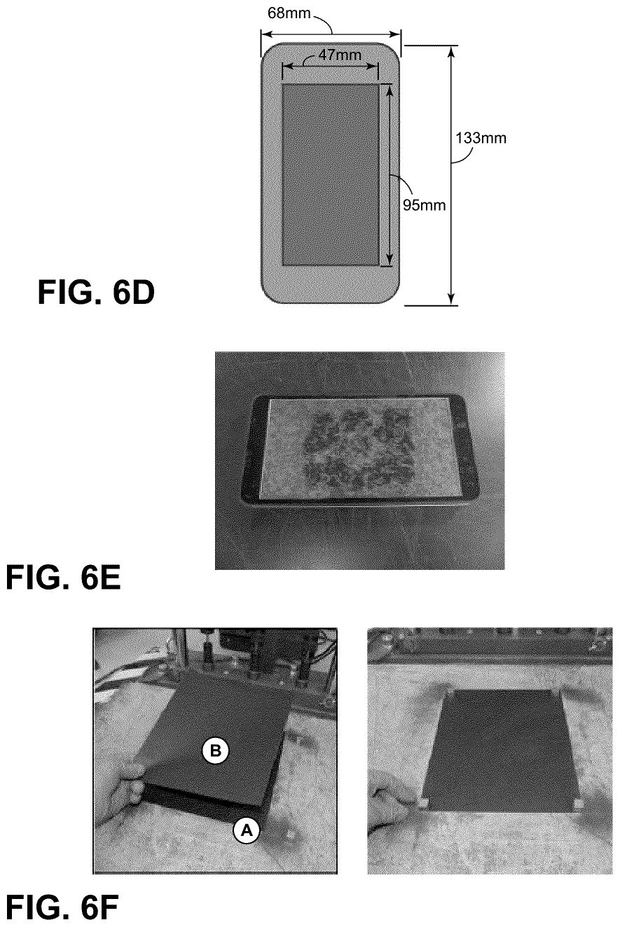

The drop testing of this example was carried out using a “puck” designed to simulate a mobile handheld device from specific heights (from 22 cm to 220 cm) and specific angles (0 deg, 30 deg, etc.) on desired drop surfaces (specific grit sandpapers (30 grit, 80 grit, 180 grit), sandpaper grits with various materials (e.g., Al₂O₃, garnet), rough granite, asphalt, etc.)). The drop testing was done using a commercial drop tower manufactured by Shinyei Corporation, (however one may use a machine from a different manufacturer with similar capabilities). An example drop tower is shown in FIG. 6A. The drop tower has a drop platform (A), a drop surface (B), stop buffers (C), a chuck assembly (D), and electro-magnetic chuck lifter I, a chuck raise/lower winch (F), guide rods (G), and a main control panel (H).

The transparent articles to be tested were assembled in a puck designed to simulate a mobile handheld device. A cross-section of the puck is shown in FIG. 6B. FIG. 6C shows a detailed view of the puck. The particular features of the puck depicted in FIGS. 6B and 6C are detailed below in Table 5A.

TABLE 5A
Elements of Puck Used for Drop Test

| Element | Element No. |
|---|---|
| cover glass | 601 |
| optically clear adhesive (OCA) film, cover glass | 601a |
| LCM glass | 602 |
| polycarbonate | 603 |
| front back cover | 604 |
| circuit board | 605 |
| magnetic sheet | 606 |
| steel plate | 607 |
| OCA thick film, display stack | 608 |
| display simulator | 609 |
| OCA thick film, display stack (2X) | 610 |
| bezel | 611 |
| threaded insert | 612 |
| battery | 613 |
| Phillips drive screws | 614 |

FIG. 6D shows a schematic view of the back of the puck, which has an appearance similar to a mobile handheld device. FIG. 6E shows an example of a cover glass in an assembled puck. Properties of the puck are shown below in Table 5B.

TABLE 5B
Puck for Drop Test

| Property | Puck |
|---|---|
| Mass (g) | 200 |
| Glass size X/Y (mm) | 130.2 × 65.2 |
| Mass/Unit area (g/mm\hat{ }2) | 0.02355979 |
| Bezel proud (mm) | 0.05 |

For controlled and repeatable drop testing in this example, the drops were done at a specific angle and on a specific sandpaper that mimics real life surface. The puck was dropped flat (Zero degree) on 3M 80 grit sandpaper. For Flat face drop on 3M 80 grit Garnet sandpaper, first the drop surface is prepared as shown in FIG. 6F. Two layers of sandpaper were used, the bottom sandpaper “A” is 180 grit Al₂O₃ paper which acts as the base and the desired test surface “B”, here 80 Grit 3M Garnet sandpaper “B” was laid on top of “A”. The bottom sheet (A) remains in-place, drop after drop, and served simply as a means of preventing the top sheet from moving from its staged location. The top sheet (B) was changed every time a new device was loaded (i.e.: for each device tested one sandpaper sheet was used). Magnets were placed at the corners of the sandpaper for additional stability. This held the sandpaper in-place during the drop procedure and there was no displacement. It was made sure that the sandpaper was flat, and had no visible damage in the target center area where the Puck device was to be dropped. For flat face drop testing the assembled puck with cover glass is aligned in the jaws of the drop tower to be flat using dual axis inclinometer and made sure the angles are aligned to zero degrees.

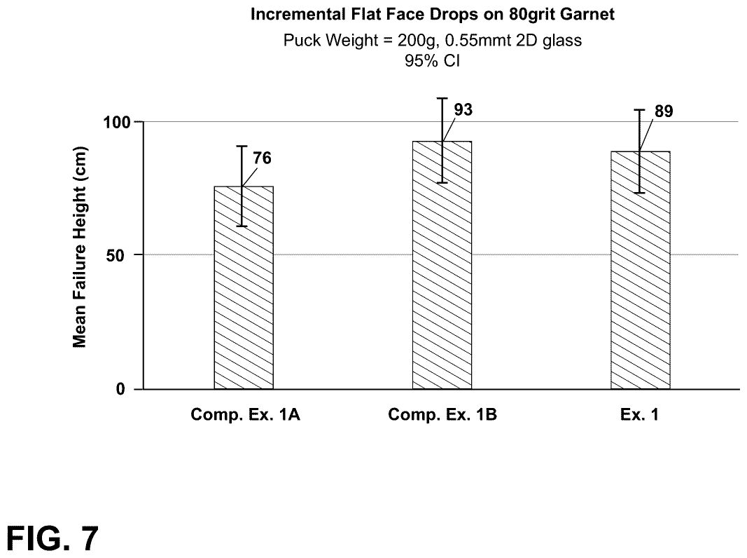

The results from the Drop Test Method conducted according to this example are shown in FIG. 7. In particular, this figure is a bar chart of mean failure height data for a transparent article of the disclosure (Ex. 1), the bare control substrate (Comp. Ex. 1A) and a comparative transparent article (Comp. Ex. 1B). As is evident from FIG. 7, mean failure height of the transparent article of this disclosure (Ex. 1) is statistically equivalent to or higher than the mean failure heights of the bare control substrate (Comp. Ex. 1A) and the comparative transparent article (Comp. Ex. 1B). Accordingly, the transparent article of the disclosure demonstrates retained or improved drop resistance relative to the uncoated control glass (Comp. Ex. 1A, and retained drop resistance compared to a comparative transparent article with a thicker coating (Comp. Ex. 1B), while also exhibiting the foregoing advantageous optical (e.g., low photopic reflectance, low IR reflectance, and low color shift with various optical film structure thickness scaling factors) and mechanical properties (e.g., high shallow hardness and reduced total coating thickness).

Aspect 1. A transparent article includes: a substrate including a first primary surface and a second primary surface, the primary surfaces opposing one another; and an optical film structure having an outer surface and a physical thickness of from about 200 nm to 5000 nm, the optical film structure disposed on the first primary surface. The optical film structure includes a scratch-resistant layer, at least one low refractive index (RI) layer, at least one medium RI layer, and at least one high RI layer. The optical film structure further includes an outer structure and an inner structure, the scratch-resistant layer disposed between the outer and inner structures, the inner structure disposed on the first primary surface, and the outer structure including a plurality of alternating high and medium RI layers. The outer structure includes at least one medium RI layer in contact with one or both of: (a) the scratch-resistant layer and (b) one of the high RI layers. The at least one medium RI layer includes a refractive index from 1.55 to 1.9, each of the high RI layers includes a refractive index of greater than 1.80, each of the low RI layers includes a refractive index from 1.35 to 1.7, each medium RI layer has a higher refractive index than each low RI layer, and each high RI layer has a higher refractive index than each medium RI layer. The article exhibits a first-surface average photopic reflectance of less than 1%, as measured from 0° to 10° incidence. Further, the article exhibits a color shift of less than 15 for all thickness scaling factors from 70-100% for the optical film structure, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

Aspect 2. The transparent article of Aspect 1 is provided, wherein the article exhibits a color shift for the optical film structure of less than 6.5 for all thickness scaling factors from 90-100%, less than 8.5 for all thickness scaling factors from 80-100%, or less than 12 for all thickness scaling factors from 75-100%, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

Aspect 3. The transparent article of Aspect 1 or Aspect 2 is provided, wherein the inner structure includes a plurality of alternating high RI layers of SiOₓN_{y} and low RI layers of SiO₂ and the outer structure includes a plurality of alternating high RI layers of SiNₓ and medium RI layers of SiOₓN_{y}.

Aspect 4. The transparent article of any one of Aspects 1-3 is provided, wherein the article exhibits a first-surface reflectance of less than 3%, as measured at an infrared wavelength of 940 nm.

Aspect 5. The transparent article of any one of Aspects 1-4 is provided, wherein the optical film structure has a physical thickness of from about 500 nm to 2000 nm.

Aspect 6. The transparent article of any one of Aspects 1-5 is provided, wherein the article exhibits one or more of: (i) a hardness of greater than 7 GPa at an indentation depth of about 20 nm or 40 nm; (ii) a hardness of greater than 11 GPa at an indentation depth of 100 nm; (iii) a hardness of greater than 12 GPa at an indentation depth of 125 nm; and (iv) a maximum hardness over all indentation depths from 50-1000 nm of greater than 14 GPa, as measured by a Berkovich Hardness Test at the outer surface of the optical film structure, and further wherein the article exhibits a mean failure height of at least 75 cm, as measured according to a Drop Test Method with 80 grit garnet sandpaper.

Aspect 7. The transparent article of any one of Aspects 1-6 is provided, wherein each medium RI layer of the outer structure includes a refractive index from 1.55 to 1.65.

Aspect 8. The transparent article of any one of Aspects 1-7 is provided, wherein substrate includes the following composition: 50-70 mol % SiO₂; 10-20 mol % Al₂O₃; 0-2 mol % P₂O₅; 1-6 mol % B203; 5-10 mol % Li₂O; 1-10 mol % Na₂O; and 0.01-1.0 mol % K₂O.

Aspect 9. The transparent article of any one of Aspects 1-8 is provided, wherein the substrate is a glass-ceramic material that includes an elastic modulus of greater than 85 GPa and a fracture toughness of greater than 0.8 MPa·√m.

Aspect 10. The transparent article of any one of Aspects 1-9 is provided, wherein the optical film structure exhibits a residual compressive stress of from 700 MPa to 1100 MPa and an elastic modulus of from 140 GPa to 200 GPa.

Aspect 11. A display device including the transparent article of any one of Aspects 1-10 is provided, wherein the transparent article serves as a protective cover for the display device.

Aspect 12. A transparent article includes: a substrate including a first primary surface and a second primary surface, the primary surfaces opposing one another; and an optical film structure having an outer surface and a physical thickness of from about 500 nm to 2000 nm, the optical film structure disposed on the first primary surface. The optical film structure includes a scratch-resistant layer, low refractive index (RI) layers, medium RI layers, and high RI layers. The optical film structure further includes an outer structure and an inner structure, the scratch-resistant layer disposed between the outer and inner structures, the inner structure disposed on the first primary surface and including a plurality of alternating high and low RI layers, and the outer structure including a plurality of alternating high and medium RI layers. The outer structure includes at least one medium RI layer in contact with one or both of: (a) the scratch-resistant layer and (b) one of the high RI layers. Each medium RI layer of the outer structure includes a refractive index from 1.55 to 1.65, each of the high RI layers includes a refractive index of greater than 1.80, and each of the low RI layers includes a refractive index from 1.35 to 1.55. Further, the article exhibits a first-surface average photopic reflectance of less than 1%, as measured from 0° to 10° incidence.

Aspect 13. The transparent article of Aspect 12 is provided, wherein the scratch-resistant layer has a physical thickness of from about 500 nm to less than 1500 nm.

Aspect 14. The transparent article of Aspect 12 or Aspect 13 is provided, wherein each of the outer structure and the inner structure has a total of at least eight (8) layers.

Aspect 15. The transparent article of any one of Aspects 12-14 is provided, wherein the optical film structure has a total of at least 15 layers.

Aspect 16. The transparent article of any one of Aspects 12-15 is provided, wherein the outer structure includes at least four (4) medium RI layers, and further wherein the outer structure further includes at least four (4) high RI layers, and further wherein one of the high RI layers in the outer structure is in contact with an outermost low RI layer.

Aspect 17. The transparent article of any one of Aspects 12-16 is provided, wherein the inner structure includes a plurality of alternating high RI layers of SiOₓN_{y} and low RI layers of SiO₂ and the outer structure includes a plurality of alternating high RI layers of SiNₓ and medium RI layers of SiOₓN_{y}.

Aspect 18. The transparent article of any one of Aspects 12-17 is provided, wherein the physical thickness of the optical film structure is from about 1500 nm to 2000 nm.

Aspect 19. The transparent article of any one of Aspects 12-18 is provided, wherein the article exhibits a color shift of less than 15 for all thickness scaling factors from 70-100% for the optical film structure, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

Aspect 20. The transparent article of any one of Aspects 12-19 is provided, wherein the article exhibits one or more of: (i) a hardness of greater than 7 GPa at an indentation depth of about 20 nm or 40 nm; (ii) a hardness of greater than 11 GPa at an indentation depth of 100 nm; (iii) a hardness of greater than 12 GPa at an indentation depth of 125 nm; and (iv) a maximum hardness over all indentation depths from 50-1000 nm of greater than 14 GPa, as measured by a Berkovich Hardness Test at the outer surface of the optical film structure, and further wherein the article exhibits a mean failure height of at least 75 cm, as measured according to a Drop Test Method with 80 grit garnet sandpaper.

Aspect 21. The transparent article of any one of Aspects 12-20 is provided, wherein substrate includes the following composition: 50-70 mol % SiO₂; 10-20 mol % Al₂O₃; 0-2 mol % P₂O₅; 1-6 mol % B203; 5-10 mol % Li₂O; 1-10 mol % Na₂O; and 0.01-1.0 mol % K₂O.

Aspect 22. The transparent article of any one of Aspects 12-21 is provided, wherein the substrate is a glass-ceramic material that includes an elastic modulus of greater than 85 GPa and a fracture toughness of greater than 0.8 MPa·√m.

Aspect 23. The transparent article of any one of Aspects 12-22 is provided, wherein the optical film structure exhibits a residual compressive stress of from 700 MPa to 1100 MPa and an elastic modulus of from 140 GPa to 200 GPa.

Aspect 24. A display device including the transparent article of any one of Aspects 12-23 is provided, wherein the transparent article serves as a protective cover for the display device.

Aspect 25. A transparent article includes: a substrate including a first primary surface and a second primary surface, the primary surfaces opposing one another; and an optical film structure having an outer surface and a physical thickness of from about 200 nm to 5000 nm, the optical film structure disposed on the first primary surface. The optical film structure includes a scratch-resistant layer, low refractive index (RI) layers, medium RI layers, and high RI layers. The optical film structure further includes an outer structure and an inner structure, the scratch-resistant layer disposed between the outer and inner structures, the inner structure disposed on the first primary surface and including a plurality of alternating high and low RI layers, and the outer structure including a plurality of alternating high and medium RI layers. The outer structure has a physical thickness of from 400 nm to 800 nm and includes at least one medium RI layer in contact with one or both of: (a) the scratch-resistant layer and (b) one of the high RI layers. The at least one medium RI layer includes a refractive index from 1.55 to 1.9, each of the high RI layers includes a refractive index of greater than 1.80, each of the low RI layers includes a refractive index from 1.35 to 1.7, each medium RI layer has a higher refractive index than each low RI layer, and each high RI layer has a higher refractive index than each medium RI layer. Further, the article exhibits a mean failure height of at least 75 cm, as measured according to a Drop Test Method with 80 grit garnet sandpaper.

Aspect 26. The transparent article of Aspect 25 is provided, wherein the article exhibits a mean failure height of at least 85 cm, as measured according to a Drop Test Method with 80 grit garnet sandpaper.

Aspect 27. The transparent article of Aspect 25 or Aspect 26 is provided, wherein the physical thickness of the optical film structure is from about 1500 nm to 2000 nm.

Aspect 28. The transparent article of any one of Aspects 25-28 is provided, wherein the substrate is a glass-ceramic material that includes an elastic modulus of greater than 85 GPa and a fracture toughness of greater than 0.8 MPa·√m.

Aspect 29. The transparent article of any one of Aspects 25-28 is provided, wherein the optical film structure exhibits a residual compressive stress of from 700 MPa to 1100 MPa and an elastic modulus of from 140 GPa to 200 GPa.

Aspect 30. The transparent article of any one of Aspects 25-29 is provided, wherein the article exhibits a first-surface average photopic reflectance of less than 1%, as measured from 0° to 10° incidence, and further wherein the article exhibits a color shift of less than 15 for all thickness scaling factors from 70-100% for the optical film structure, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

Aspect 31. The transparent article of any one of Aspects 25-30 is provided, wherein each medium RI layer of the outer structure includes a refractive index from 1.55 to 1.65.

Aspect 32. The transparent article of any one of Aspects 25-31 is provided, wherein substrate includes the following composition: 50-70 mol % SiO₂; 10-20 mol % Al₂O₃; 0-2 mol % P₂O₅; 1-6 mol % B₂O₃; 5-10 mol % Li₂O; 1-10 mol % Na₂O; and 0.01-1.0 mol % K₂O.

Aspect 33. The transparent article of any one of Aspects 25-32 is provided, wherein the inner structure includes a plurality of alternating high RI layers of SiOₓN_{y} and low RI layers of SiO₂ and the outer structure includes a plurality of alternating high RI layers of SiNₓ and medium RI layers of SiOₓN_{y}.

Aspect 34. A display device including the transparent article of any one of Aspects 25-33 is provided, wherein the transparent article serves as a protective cover for the display device.

Aspect 35. The transparent article of any one of Aspects 1-11 is provided, wherein the substrate is a non-planar substrate.

Aspect 36. The transparent article of any one of Aspects 12-24 is provided, wherein the substrate is a non-planar substrate.

Aspect 37. The transparent article of any one of Aspects 25-34 is provided, wherein the substrate is a non-planar substrate.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that has been set forth and defined within the following claims. cm What is claimed is:

1. A transparent article, comprising:
a substrate comprising a first primary surface and a second primary surface, the primary surfaces opposing one another; and
an optical film structure having an outer surface and a physical thickness of from about 200 nm to 5000 nm, the optical film structure disposed on the first primary surface,
wherein the optical film structure comprises a scratch-resistant layer, at least one low refractive index (RI) layer, at least one medium RI layer, and at least one high RI layer,
wherein the optical film structure further comprises an outer structure and an inner structure, the scratch-resistant layer disposed between the outer and inner structures, the inner structure disposed on the first primary surface, and the outer structure comprising a plurality of alternating high and medium RI layers,
wherein the outer structure comprises at least one medium RI layer in contact with one or both of: (a) the scratch-resistant layer and (b) one of the high RI layers,
wherein the at least one medium RI layer comprises a refractive index from 1.55 to 1.9, each of the high RI layers comprises a refractive index of greater than 1.80, each of the low RI layers comprises a refractive index from 1.35 to 1.7, each medium RI layer has a higher refractive index than each low RI layer, and each high RI layer has a higher refractive index than each medium RI layer,
wherein the article exhibits a first-surface average photopic reflectance of less than 1%, as measured from 0° to 10° incidence, and
further wherein the article exhibits a color shift of less than 15 for all thickness scaling factors from 70-100% for the optical film structure, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

2. The transparent article of claim 1, wherein the article exhibits a color shift for the optical film structure of less than 6.5 for all thickness scaling factors from 90-100%, less than 8.5 for all thickness scaling factors from 80-100%, or less than 12 for all thickness scaling factors from 75-100%, as measured in first-surface reflectance per one or both of: (i) all incident angles in a range of 0° to 90° or (ii) between two angles of incidence, where the first angle is selected from the range of 0-20 degrees and the second angle is selected from the range of 45-90 degrees, and as given by √(a*²+b*²), where a* and b* are color coordinates in the CIE L*, a*, b* colorimetry system under a D65 illuminant.

3. The transparent article of claim 1, wherein the inner structure comprises a plurality of alternating high RI layers of SiOₓN_{y} and low RI layers of SiO₂ and the outer structure comprises a plurality of alternating high RI layers of SiNₓ and medium RI layers of SiOₓN_{y}.

4. The transparent article of claim 1, wherein the article exhibits one or more of: (i) a hardness of greater than 7 GPa at an indentation depth of about 20 nm or 40 nm; (ii) a hardness of greater than 11 GPa at an indentation depth of 100 nm; (iii) a hardness of greater than 12 GPa at an indentation depth of 125 nm; and (iv) a maximum hardness over all indentation depths from 50-1000 nm of greater than 14 GPa, as measured by a Berkovich Hardness Test at the outer surface of the optical film structure, and further wherein the article exhibits a mean failure height of at least 75 cm, as measured according to a Drop Test Method with 80 grit garnet sandpaper.

5. The transparent article of claim 1, wherein substrate comprises the following composition:
50-70 mol % SiO₂;
10-20 mol % Al₂O₃;
0-2 mol % P₂O₅;
1-6 mol % B₂O₃;
5-10 mol % Li₂O;
1-10 mol % Na₂O; and
0.01-1.0 mol % K₂O.

6. The transparent article of claim 1, wherein:
the substrate is a glass-ceramic material that comprises an elastic modulus of greater than 85 GPa and a fracture toughness of greater than 0.8 MPa·√m; and
the optical film structure exhibits a residual compressive stress of from 700 MPa to 1100 MPa and an elastic modulus of from 140 GPa to 200 GPa.

7. The transparent article of claim 1, wherein the substrate is a non-planar substrate.

8. A transparent article, comprising:
a substrate comprising a first primary surface and a second primary surface, the primary surfaces opposing one another; and
an optical film structure having an outer surface and a physical thickness of from about 500 nm to 2000 nm, the optical film structure disposed on the first primary surface,
wherein the optical film structure comprises a scratch-resistant layer, low refractive index (RI) layers, medium RI layers, and high RI layers,
wherein the optical film structure further comprises an outer structure and an inner structure, the scratch-resistant layer disposed between the outer and inner structures, the inner structure disposed on the first primary surface and comprising a plurality of alternating high and low RI layers, and the outer structure comprising a plurality of alternating high and medium RI layers,
wherein the outer structure comprises at least one medium RI layer in contact with one or both of: (a) the scratch-resistant layer and (b) one of the high RI layers, and
wherein each medium RI layer of the outer structure comprises a refractive index from 1.55 to 1.65, each of the high RI layers comprises a refractive index of greater than 1.80, and each of the low RI layers comprises a refractive index from 1.35 to 1.55, and
wherein the article exhibits a first-surface average photopic reflectance of less than 1%, as measured from 0° to 10° incidence.

9. The transparent article of claim 8, wherein the scratch-resistant layer has a physical thickness of from about 500 nm to less than 1500 nm.

10. The transparent article of claim 8, wherein each of the outer structure and the inner structure has a total of at least eight (8) layers.

11. The transparent article of claim 8, wherein the optical film structure has a total of at least 15 layers.

12. The transparent article of claim 8, wherein the outer structure comprises at least four (4) medium RI layers, and further wherein the outer structure further comprises at least four (4) high RI layers, and further wherein one of the high RI layers in the outer structure is in contact with an outermost low RI layer.

13. The transparent article of claim 8, wherein the inner structure comprises a plurality of alternating high RI layers of SiOₓ N_{y} and low RI layers of SiO₂ and the outer structure comprises a plurality of alternating high RI layers of SiNₓ and medium RI layers of SiOₓN_{y}.

14. The transparent article of claim 8, wherein:
the substrate is a glass-ceramic material that comprises an elastic modulus of greater than 85 GPa and a fracture toughness of greater than 0.8 MPa·√m; and,
the optical film structure exhibits a residual compressive stress of from 700 MPa to 1100 MPa and an elastic modulus of from 140 GPa to 200 GPa.

15. The transparent article of claim 8, wherein the substrate is a non-planar substrate.

16. A transparent article, comprising:
a substrate comprising a first primary surface and a second primary surface, the primary surfaces opposing one another; and
an optical film structure having an outer surface and a physical thickness of from about 200 nm to 5000 nm, the optical film structure disposed on the first primary surface,
wherein the optical film structure comprises a scratch-resistant layer, low refractive index (RI) layers, medium RI layers, and high RI layers,
wherein the optical film structure further comprises an outer structure and an inner structure, the scratch-resistant layer disposed between the outer and inner structures, the inner structure disposed on the first primary surface and comprising a plurality of alternating high and low RI layers, and the outer structure comprising a plurality of alternating high and medium RI layers,
wherein the outer structure has a physical thickness of from 400 nm to 800 nm and comprises at least one medium RI layer in contact with one or both of: (a) the scratch-resistant layer and (b) one of the high RI layers,
wherein the at least one medium RI layer comprises a refractive index from 1.55 to 1.9, each of the high RI layers comprises a refractive index of greater than 1.80, each of the low RI layers comprises a refractive index from 1.35 to 1.7, each medium RI layer has a higher refractive index than each low RI layer, and each high RI layer has a higher refractive index than each medium RI layer, and
further wherein the article exhibits a mean failure height of at least 75 cm, as measured according to a Drop Test Method with 80 grit garnet sandpaper.

17. The transparent article of claim 16, wherein the article exhibits a mean failure height of at least 85 cm, as measured according to a Drop Test Method with 80 grit garnet sandpaper.

18. The transparent article of claim 16, wherein:
the substrate is a glass-ceramic material that comprises an elastic modulus of greater than 85 GPa and a fracture toughness of greater than 0.8 MPa·√m; and
the optical film structure exhibits a residual compressive stress of from 700 MPa to 1100 MPa and an elastic modulus of from 140 GPa to 200 GPa.

19. The transparent article of claim 16, wherein the inner structure comprises a plurality of alternating high RI layers of SiOₓN_{y} and low RI layers of SiO₂ and the outer structure comprises a plurality of alternating high RI layers of SiNₓ and medium RI layers of SiOₓN_{y}.

20. The transparent article of claim 16, wherein the substrate is a non-planar substrate.
